(19) United States
(12) Patent Application Publication
(10) Pub. No.: US 2026/0129695 A1
(43) Pub. Date: May 7, 2026

(54) SYSTEM AND METHOD FOR PDU SESSION ESTABLISHMENT IN AN END-TO-END SERVICE-BASED ENVIRONMENT

(71) Applicant: Samsung Electronics Co., Ltd., Suwon-si (KR)

(72) Inventors: Avneesh TIWARI, Bangalore (IN); Manasi EKKUNDI, Bangalore (IN); Neha SHARMA, Bangalore (IN)

(21) Appl. No.: 19/427,099

(22) Filed: Dec. 19, 2025

Related U.S. Application Data
(63) Continuation of application No. PCT/KR2024/012466, filed on Aug. 21, 2024.

(30) Foreign Application Priority Data
Aug. 22, 2023 (IN) 202341056117
Sep. 6, 2023 (IN) 202341059952
Aug. 14, 2024 (IN) 2023 41056117

(51) Int. Cl. H04W 76/12; H04W 8/02; H04W 48/16; H04W 84/04

(52) U.S. Cl. CPC H04W 76/12; H04W 8/02; H04W 48/16; H04W 84/042

(57) ABSTRACT

A method performed by a central unit control plane (CU-CP) network function (NF) for protocol data unit (PDU) session establishment in an end-to-end service-based environment is provided. The method includes receiving, from a user equipment (UE), a non-access stratum (NAS) messages comprising a PDU session establishment request obtaining a decoded NAS message in response to receiving the NAS message, selecting a session management function (SMF) based on the decoded NAS message, receiving, from the selected SMF, PDU session details, and transmitting, to the UE, the PDU session details to facilitate an establishment of the PDU session.

### CROSS-REFERENCE TO RELATED APPLICATION(S)

This application is a continuation application, claiming priority under 35 U.S.C. § 365(c), of an International application No. PCT/KR2024/012466, filed on Aug. 21, 2024, which is based on and claims the benefit of a Indian Provisional patent application number 202341056117, filed on Aug. 22, 2023, in the India Intellectual Property Office, of a Indian patent application number 202341059952, filed on Sep. 6, 2023, in the Indian Intellectual Property Office, and of an Indian Complete patent application number 202341056117, filed on Aug. 14, 2024, in the Indian Intellectual Property Office, the disclosure of each of which is incorporated by reference herein in its entirety.

### BACKGROUND

### 1. Field

The disclosure relates to communication protocol networks. More particularly, the disclosure relates to a framework design(s) of a service-based radio access network (RAN) and protocol data unit (PDU) session establishment after selecting a session management function in sixth generation (6G).

### 2. Description of Related Art

Wireless technology has been continuously evolving to provide for the growing demand for services and requirements of end users. The earliest generation referred to as second generation (2G) of wireless communication provided mobility and voice services while the third generation (3G) provided voice and data services. However, with the growing demand for high-speed data, there was a need to further evolve and a fourth generation (4G) of wireless communication was developed. In the 4G communication systems, multiple architecture options were designed to provide high-speed data. These systems included aggregating multiple carriers either through carrier aggregation (CA) or through dual connectivity (DC) which allowed operators to provide high data rates per user through the aggregation of the respective radio resources. Furthermore, with growing demands for even higher data rates, ultra-reliability, low latency communication requirements, and machine-type communications, the next generation of wireless technology, i.e., fifth generation (5G) communication systems developed. The 5G architecture consists of two parts—a radio network (NG-RAN) and a 5G core network (5GC) which have had major changes compared to earlier technologies.

In other industries, cloud-native architectures and web-scale technologies such as hypertext transfer protocol (HTTP) have found massive usage and advantages, which are incorporated in 5G network architecture design to meet the growing telecommunication requirements, and further, design a new approach for developing network architecture and delivering services.

One such architectural aspect is the support of a service-based architecture to provide modular network services in the 5GC. TS 23.501 describes the service-based architecture of 5GC and the interaction between network functions is represented in the following two ways, as explained in FIGS. 1A and 1B below:

FIG. 1A shows an architecture of the 5G communication system in a non-roaming case, using the reference point representation to show how various network functions interact with each other, according to the related art.

The reference point representation shows that an interaction exists between network functions (NF) services in the network functions described by a point-to-point reference point (for example, N11 as shown in FIG. 1A) between any two network functions (for example, AMF and Session Management Function (SMF)).

FIG. 1B shows a non-roaming reference architecture of the 5G communication system with service-based interfaces, according to the related art.

The service-based interfaces are used within the control plane (CP) network functions. In the service-based representation, network functions (e.g., access and mobility management function (AMF)) within a control plane (CP) enable other authorized network functions to access their services. This representation also includes point-to-point reference points wherever necessary.

A 5G service-based core network architecture brings more scalability and flexibility as any network function (NF) node can interact with any other node in the 5G system architecture. The 5G system architecture may leverage service-based interactions between CP (control plane) network functions. In this case, a set of NFs provides services to other authorized NFs to access their services through a service based interface (SBI). An NF service is one type of capability exposed by an NF (NF service producer) to other authorized NF (NF service consumer) through the service-based interface. The NF service may support one or more NF service operation(s). The network functions may offer different functionalities and thus different NF services. Each of the NF services offered by the network functions may be self-contained, acted upon, and managed independently from the other NF services offered by the same network function (e.g., for scaling).

The SBI represents how the set of services is provided or exposed by a given NF. This is an interface where the NF service operations are invoked. The following control plane interfaces within the 5G service-based core network architecture are specified in 3GPP TS 23.501 which are defined as service-based interfaces—Namf, Nsmf, Nudm, Nnrf, Nnssf, Nausf, Nnef, Nsmsf, Nudr, Npcf, N5g-eir, and Nlmf.

The 5G system architecture is based on the SBI, but the RAN to a core network (CN) is still a point-to-point (P2P) interaction. Due to network function virtualization, the RAN, as well as the CN, may be at the same location but still, the RAN can only interact with a single core network entity, which is the AMF.

FIG. 2A illustrates an overall architecture of a next generation-RAN (NG-RAN) consisting of a set of next generation node B (gNBs) connected to the 5GC through the NG interface, according to the related art.

Referring to FIG. 2A, the gNBs may be interconnected through an Xn interface. Further, each of the gNBs may consist of a gNB-CU (Centralized Unit) and one or more gNB-DU(s) (Distributed Unit). The gNB-CU and the gNB-DU are connected via an F1 interface.

FIG. 2B illustrates an overall architecture for the separation of gNB-CU-CP (control plane) and gNB-CU-UP (user plane) within the NG-RAN, according to the related art.

Referring to FIG. 2B, the gNB may consist of a gNB-CU-CP, multiple gNB-CU-UPs, and multiple gNB-DUs. The gNB-CU-CP is connected to the gNB-DU through the F1-C interface. The gNB-CU-UP is connected to the gNB-DU through the F1-U interface. The gNB-CU-UP is connected to the gNB-CU-CP through the E1 interface.

However, as wireless communication evolves to the next generations i.e., 6G, existing 5G-RAN nodes and 5GC may evolve to new RAN node (6G-RAN) and enhanced 5GC (e5GC) or 6G core network (6GC). In the evolution path of wireless communication, existing interfaces in between the RAN nodes and core network (CN), which is P2P interface, may also evolve to the SBI. Also, with further enhancements to cloudification and virtualization of networks, it is natural that the 6G networks may eventually see a service-based RAN interface with the CN.

In order to cater to the 6G requirements, such as efficient data transmission, different QoS, network security, network slicing, and resource optimization, PDU session establishment and management become the utmost important task. The PDU sessions are a fundamental aspect of mobile networks, which aim to provide high-speed, low latency, and reliable communication services to users, and enable new applications, and use cases in a digital era.

The establishment and management of PDU sessions are critical for the efficient functioning of modern mobile networks (i.e. 6G), as they enable seamless data transfer, enhance network security, support diverse services with different QoS needs, and allow dynamic resource allocation to meet varying traffic demands. When the RAN to CN becomes SBI, the PDU session establishment procedures need to be changed according to the service-based frameworks. Hence, there is a requirement for establishing a new method or system for the PDU session establishment in a service-based environment.

FIG. 3 illustrates a procedural call flow for the PDU session establishment after completion of a registration process, according to the related art.

The procedural call flow for the PDU session is established between a user equipment (UE), the RAN, the AMF, a user plane function (UPF), the SMF, and a unified data management (UDM). As per existing literature (3GPP TS 23.502) during PDU session establishment, the below steps may be performed:

At first, the PDU session establishment request is carried over uplink (UL) non-access stratum (NAS) transport message from RAN to AMF. The following information is contained in the message that is required to establish a PDU session:
Serving NSSAI: This is UE's preferred network slice or (Network Slice Selection Assistance Information) NSSAI where the UE was registered before.
DNN: Data Network Name is same as (Access Point Name) APN in an Evolved Packet System (EPS). This is the data service name UE wants to access.
PDU Session ID: This is a unique identifier generated by UE and cannot be same as any existing PDU session.
Request Type: This can be “Initial Request,” “Existing Session,” or “PDU session Handover”
5G session management (5GSM) Capability: This is UE's session management capabilities.
PCO: Protocol configuration option and used to request various network (NW) parameters.
SM PDU DN Request Container: This includes authorization information to access DN.

Thereafter, the AMF determines if it is a new PDU session or associated with any existing PDU session based on the request type. If the NAS message does not contain Single-Network Slice Selection Assistance Information (S-NSSAI), then the AMF selects the default NSSAI. If the NAS message contains the S-NSSAI but does not contain the DNN, then the AMF selects a default DNN for that NSSAI, if UE has a subscription to that DNN, else a local DNN is selected. If the request type is an initial request, or HO from EPS or non-3GPP, then the AMF stores a mapping of S-NSSAI, DNN, PDU-Session ID, SMF-ID, and Access Type.

Further, when the AMF does not have an association with the SMF for the PDU session ID provided by UE, the AMF sends Nsmf_PDUSession_CreateSMContextRequest. Else, Nsmf_PDUSession_UpdateSMContextRequest is sent to the SMF. Further, based on the data provided by UE, the SMF communicates with the UDM and a Policy Control Function (PCF) to get relevant information for the PDU session creation. If the request type is an initial request, the SMF initiates a N4 session establishment request with the selected UPF, otherwise, the SMF sends a N4 session modification request.

The UPF acknowledges the request of the N4 Session Establishment/Modification Response. Using N4 session establishment, the SMF gets the GTP tunnel info from the UPF. After Successful creation of a Tunnel endpoint, the SMF sends Namf_Communication_NIN2MessageTransfer with Tunnel Details for N2 message and PDU session details in N1 Container. Upon Reception of the above message, the AMF sends a NGAP PDU session Setup Request along with N2 parameter from the SMF in the above message with parameters, PDU Session ID, QFIs (QoS Flow Identifier), QoS Profile, CN tunnel Info, PDU Session type, Session AMBR (Aggregate Maximum Bit Rate). Inside the N2 message above, the AMF piggybacks N1 PDU Session Establishment Accept with NAS Header with session parameters like QoS Rules and UE IP address. Then NG RAN (gNB) sets up the GTP Tunnel based on the N2 information received from the AMF and sets up the Tunnel Endpoint (or Bearer). In addition, gNB forwarded the N1 message to UE for setting up of PDU session. The gNB after setting up the tunnel, sends back N2 PDU session setup response to the AMF.

Referring to FIG. 3, the current PDU session establishment call flow requires anchoring at the AMF where the associated information is exchanged with the RAN and the UE. However, in 6G network, solutions are being discussed for incorporating a service-based RAN with a Central Unit-User Plane (CU-CP) connected to the core network elements via the SBI. In this scenario, it is necessary to examine the PDU session establishment call flow for the new architecture and provide the associated changes to messages, information elements, and call flows and procedures.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a framework design(s) of a service-based Radio Access Network (RAN) and Protocol Data Unit (PDU) session establishment after selecting a session management function in 6G.

Additional aspects will be set forth in part in the description which follows and, in part, will be apparent from the description, or may be learned by practice of the presented embodiments.

In accordance with an aspect of the disclosure, a method performed by a central unit control plane (CU-CP) network function (NF) for protocol data unit (PDU) session establishment in an end-to-end service-based environment is provided. The method includes receiving, from a user equipment (UE), a non-access stratum (NAS) messages comprising a PDU session establishment request, obtaining a decoded NAS message in response to receiving the NAS message, selecting a session management function (SMF) based on the decoded NAS message, receiving, from the selected SMF, the PDU session details, and transmitting, to the UE, the PDU session details to facilitate establishment of the PDU session.

In accordance with another aspect of the disclosure, a CU-CP NF to receive the decoded NAS message from the AMF or the NDF is provided. The CU-CP NF is configured to send the NAS message comprising the PDU session establishment request to the AMF or the NDF via Ncucp_PDUSession_Establishment Request. The AMF or the NDF decodes the NAS message. The NDF is a network function used by any NF consumer to get decoded NAS messages.

In accordance with another aspect of the disclosure, the AMF or the NDF is configured to send the decoded NAS messages to the CU-CP NF using Nndf_NASmessage_DecodedMessage.

In accordance with another aspect of the disclosure, CU-CP NF is provided. The CU-CP NF supports SMF selection in a non-roaming and roaming with local breakout condition and home routed roaming condition.

In accordance with another aspect of the disclosure, in case of the SMF selection in the non-roaming and roaming with local breakout condition, to select the SMF based on the decoded NAS messages, the CU-CP NF is configured to determine whether SMF information is available in the CU-CP NF via local configurations.

In accordance with another aspect of the disclosure, when the SMF information is available in the CU-CP NF via the local configurations, the CU-CP NF is configured to select the SMF based on the local configurations.

In accordance with another aspect of the disclosure, when the SMF information is unavailable in the CU-CP NF via local configurations and when the CU-CP NF is aware of an appropriate network repository function (NRF), the CU-CP NF system is configured to query the NRF in a serving public land mobile network (PLMN) using Nnrf_cucpDiscovery_Request. The Nnrf_cucpDiscovery_Request comprises at least a single network slice selection assistance information (S-NSSAI) of the serving PLMN, PLMN ID of subscription permanent identifier (SUPI), data network name (DNN), and network slice instance (NSI) ID if the AMF has stored an NSI ID for the S-NSSAI of the serving PLMN for the PDU session from allowed NSSAI. Further, the CU-CP NF system is configured to receive from the NRF, fully qualified domain name (FQDN) or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In accordance with another aspect of the disclosure, when the SMF information is unavailable in the CU-CP NF via local configurations and when the CU-CP NF is unaware of an appropriate NRF, the CU-CP NF system is configured to invoke Ncucp_NssfSelection_Get service operation from a network slice selection function (NSSF) in a serving PLMN with S-NSSAI of the serving PLMN from allowed NSSAI requested by the UE with PLMN ID of SUPI, tracking area identity (TAI) of the UE, and an indication of the PDU Session establishment being either from non-roaming or roaming with local breakout scenario. Further, the CU-CP NF system is configured to receive, form the NSSF in serving PLMN, information of the NRF to be used to select NFs/services within a selected Network Slice instance. The CU-CP NF system is configured to query the NRF in serving PLMN using Nnrf_cucpDiscovery_Request. The Nnrf_cucpDiscovery_Request comprises at least S-NSSAI of the serving PLMN for the PDU Session from allowed NSSAI, PLMN ID of SUPI, DNN and NSI ID if the AMF has stored an NSI ID for the S-NSSAI of the serving PLMN for the PDU session from the allowed NSSAI, and to receive, from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In accordance with another aspect of the disclosure, in case of the SMF selection in home routed roaming condition, to select the SMF based on the decoded NAS messages, the CU-CP NF is configured to determine a NRF is available for selection of NFs/services in a home public land mobile network (HPLMN).

In accordance with another aspect of the disclosure, when the CU-CP NF is unaware of the NRF to be used to select the NFs/services in the HPLMN, the CU-CP NF is configured to invoke the Ncucp_NssfSelection_Get Request service operation from the NSSF in a visited public land mobile network (VPLMN) with VPLMN S-NSSAI, HPLMN S-NSSAI, a PLMN ID of the SUPI, a tracking area identity (TAI) of the UE, and an indication that PDU Session establishment is in the home-routed roaming condition. The CU-CP NF is further configured to receive from the NSSF in the VPLMN, information of a vNRF to be used to select NFs/services, query the NRF via Nnrf_cucpDiscovery_Request, and receive, from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In accordance with another aspect of the disclosure, upon selection of the SMF by the AMF, the AMF is configured to determine whether the AMF have an association with any SMF for the PDU session ID provided by the UE. The AMF is configured to send Nsmf_PDUSession_CreateSMContext Request to the selected SMF. The Nsmf_PDUSession_CreateSMContext Request creates an AMF-SMF association to support the PDU session, when an association of the AMF with any SMF is unavailable. The AMF is configured to receive at least one of SMF context ID, SMF ID, and SMF related information of the selected SMF via Nsmf_PDUSession_CreateSMContext Response from the selected SMF, and send at least one of the SMF context ID, the SMF ID, and the SMF related information of the selected SMF to the CU-CP NF. The CU-CP NF is configured to receive the PDU session details via Ncucp_Communication_MessageTransfer from the selected SMF.

In accordance with another aspect of the disclosure, upon selection of the SMF by the CU-CP NF, the CU-CP NF system is configured to send details of the selected SMF to the AMF via Ncucp_EventExposure_Notify. The AMF is configured to subscribe to the selected SMF via using Nsmf_EventExposure_Subscribe service operation upon receiving the SMF details from the CU-CP NF. The AMF is configured to send Ncucp_PDUSession_CreateSMContext Request to the selected SMF. The Ncucp_PDUSession_CreateSMContext Request creates an CU-CP-SMF association to support the PDU session, when an association of the CU-CP NF with any SMF is unavailable. The AMF is further configured to receive at least one of SMF context ID, SMF ID, and SMF related information of the selected SMF via Ncucp_PDUSession_CreateSMContext Response from the selected SMF and receive the PDU session details via Ncucp_Communication_MessageTransfer from the selected SMF.

In accordance with another aspect of the disclosure, a central unit control plane (CU-CP) network function (NF) for PDU session establishment in an end-to-end service-based environment is provided. The CU-CP NF includes communication circuitry, at least one processor including processing circuitry, and memory, including one or more storage media, storing instructions that, when executed by the at least one processor individually or collectively, cause the CU-CP NF to receive, from a user equipment (UE), a non-access stratum (NAS) message comprising a PDU session establishment request, obtain a decoded NAS message in response to receiving the NAS message, select a session management function (SMF) based on the decoded NAS message, receive, from the selected SMF, PDU session details, and transmit, to the UE, the PDU session details to facilitate an establishment of the PDU session.

In accordance with another aspect of the disclosure, one or more non-transitory computer-readable storage media storing one or more computer programs including computer-executable instructions that, when executed by one or more processors of a central unit control plane (CU-CP) network function (NF) individually or collectively, cause the CU-CP NF to perform operations are provided. The operations including receiving, from a user equipment (UE), a non-access stratum (NAS) message comprising a PDU session establishment request, obtaining a decoded NAS message in response to receiving the NAS message, selecting a session management function (SMF) based on the decoded NAS message, receiving, from the selected SMF, PDU session details, and transmitting, to the UE, the PDU session details to facilitate an establishment of the PDU session.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1A shows an architecture of the 5G communication system in a non-roaming case, using the reference point representation to show how various network functions interact with each other, according to the related art;

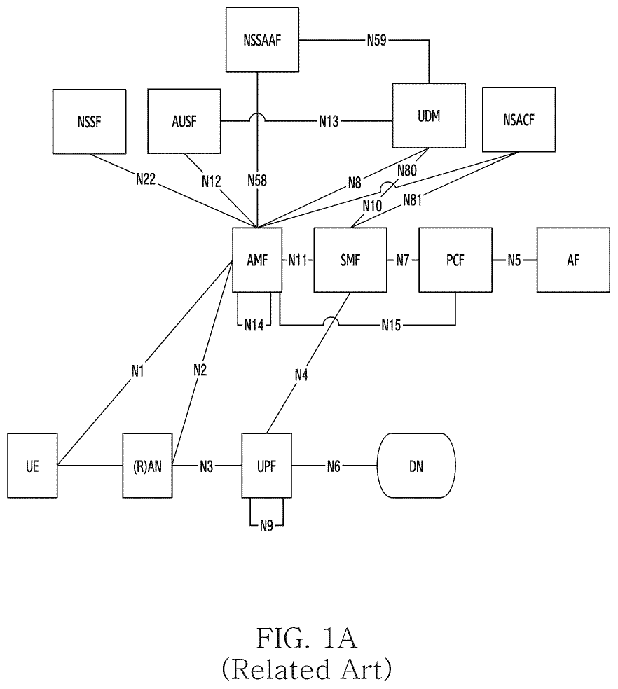

FIG. 1B shows a non-roaming reference architecture of the 5G communication system with service-based interfaces, according to the related art;

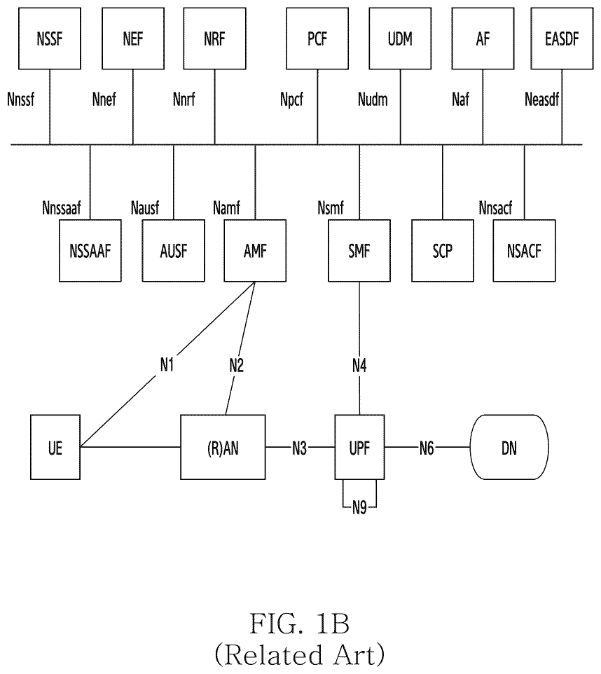

FIG. 2A illustrates an overall architecture of a Next Generation-RAN (NG-RAN) consisting of a set of Next Generation Node B (gNBs) connected to the 5GC through the NG interface, according to the related art;

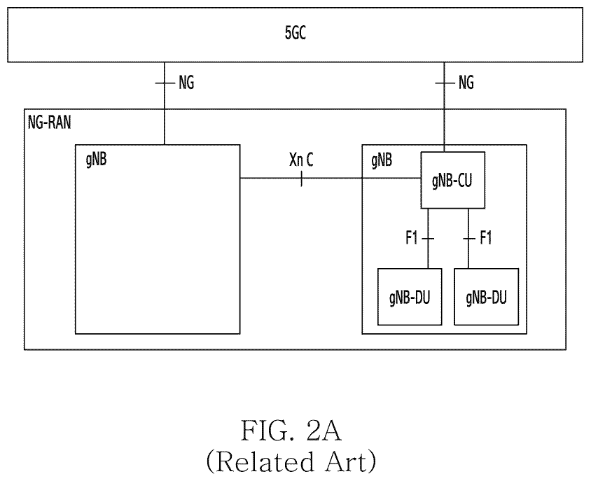

FIG. 2B illustrates an overall architecture for the separation of gNB-CU-CP (control plane) and gNB-CU-UP (user plane) within the Next Generation-RAN (NG-RAN), according to the related art;

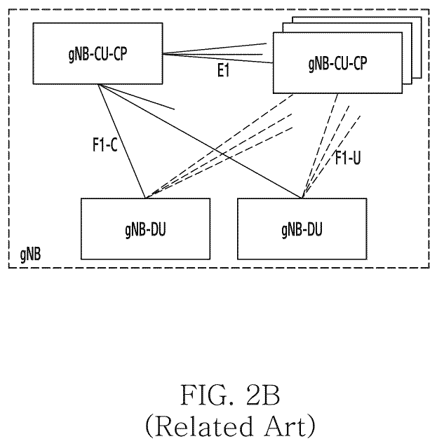

FIG. 3 illustrates a procedural call flow for the PDU session establishment after completion of a registration process, according to the related art;

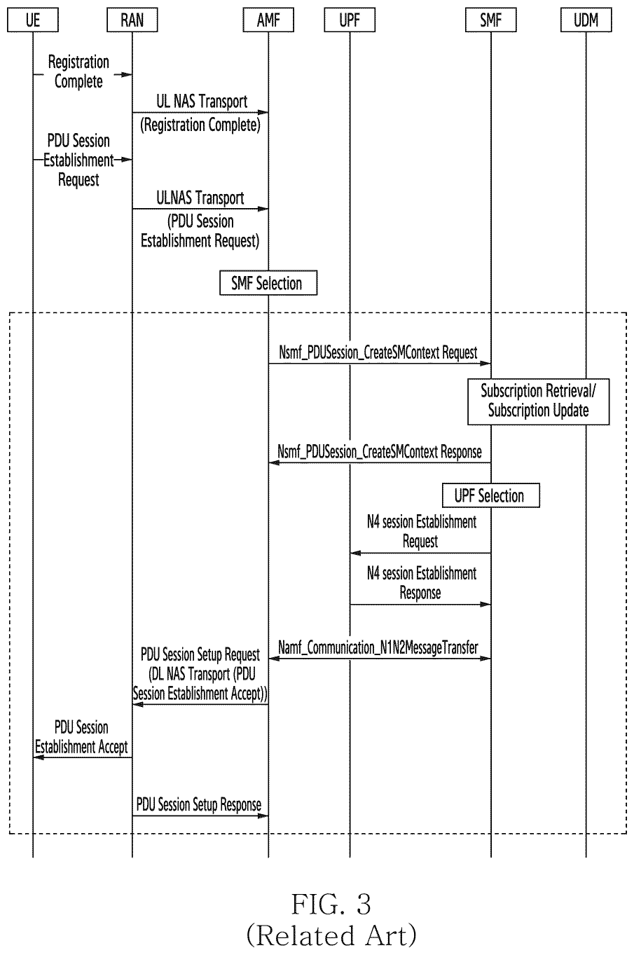

FIG. 4 illustrates a network system having an end-to-end service-based architecture, according to an embodiment of the disclosure;

FIG. 5 illustrates a session establishment procedural call flow when UE sends a request to CU-CP NF according to an embodiment of the disclosure;

FIG. 6 illustrates SMF selection by RAN NF with AMF assisted when UE sends a request to the CU-CP NF according to an embodiment of the disclosure;

FIG. 7 illustrates the steps of SMF selection procedural call flow when the serving CU-CP NF is not aware of an appropriate NRF to be used to select NFs/services within the corresponding network slice instance (non-roaming and roaming with local breakout) according to an embodiment of the disclosure;

FIG. 8 illustrates the steps of SMF selection procedural call flow when the serving CU-CP NF is not aware of an appropriate NRF to be used to select NFs/services within the corresponding network slice instance (Home routed roaming) according to an embodiment of the disclosure;

FIG. 9 illustrates the steps of SMF selection procedural call flow (Home routed roaming with option 2) according to an embodiment of the disclosure;

FIG. 10 illustrates SMF Selection by RAN (CU-CP NF) using NAS functionality within RAN, according to an embodiment of the disclosure;

FIG. 11 illustrates SMF Selection by CU-CP NF using a new network function for NAS container decoding, according to an embodiment of the disclosure;

FIG. 12 illustrates a PDU session establishment when AMF performs SMF selection, according to an embodiment of the disclosure;

FIG. 13 illustrates a PDU session establishment when RAN-NF (CU-CP) performs the SMF selection, according to an embodiment of the disclosure; and

FIG. 14 illustrates a method for PDU session establishment in an end-to-end service-based environment, according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the document, the word “exemplary” is used herein to mean “serving as an example, instance, or illustration.” Any embodiment or implementation of the subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described and will be described in detail below. It should be understood that, however it is not intended to limit the disclosure is to cover all modifications, equivalents, and alternatives falling within the spirit and the scope of the disclosure.

The terms “comprises”, “comprising”, or any other variations thereof, are intended to cover a non-exclusive inclusion, such that a setup, device or method that comprises a list of components or steps does not include only those components or steps but may include other components or steps not expressly listed in a device or system or apparatus proceeded by “comprises . . . a” does not, without more constraints, preclude the existence of other elements or additional elements in the device or system or apparatus.

In the following detailed description of the embodiments of the disclosure, reference is made to the accompanying drawings that form a part hereof, and which are shown by way of illustration specific embodiments in which the disclosure may be practiced. These embodiments are described in sufficient detail to enable those skilled in art to practice the disclosure, and it is to be understood that other embodiments may be utilized and that changes may be made without departing from the scope of the disclosure. The following description is, therefore, not to be taken in a limiting sense.

Embodiments of the disclosure describe a method for PDU session establishment after session management function selection in a Sixth Generation (6G) communication system. According to the disclosure, 6G architecture may enable an evolution of an end-to-end service-based architecture to make the 6G system architecture more efficient, flexible, and simple. To support such evolution, the disclosure defines multiple PDU session establishment procedures when RAN module(s) (i.e., CU-CP (Central Unit Control Plane, CU-UP (Central Unit User Plane), and DU (Distributed Unit)) start supporting Service-based architecture. Also, the terms “6G-AN”, “RAN NF” and “CU-CP NF” have been used interchangeably throughout the specification and drawings.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth© chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

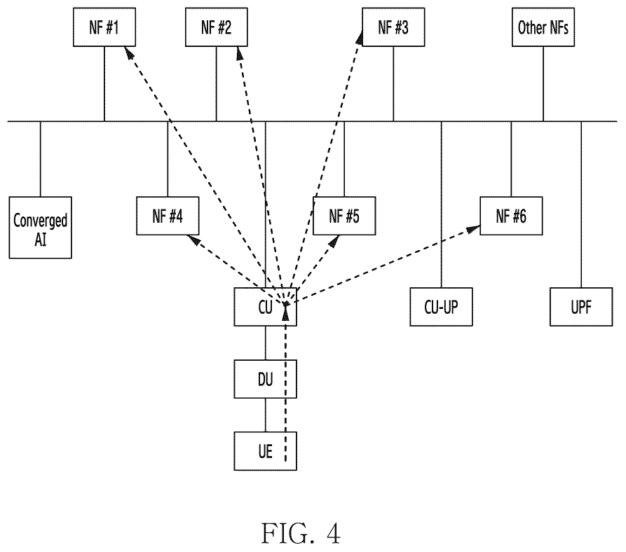

FIG. 4 illustrates a network system having an end-to-end service-based architecture, according to an embodiment of the disclosure.

Referring to FIG. 4, all the core network entities (NF #1, NF #2, etc.), UE, and RAN entity (CU) may be connected with each other via service-based interfaces (SBI). The terms CU-CP and CU are used interchangeably throughout the specification, without deviating from the scope of the disclosure.

Here in this embodiment, it is to be noted that, in the disclosure, SMF refers to a network function that is responsible for providing the session management functions (SMF). In the subsequent 3GPP specifications for 6G, the reference to such a network function can be the SMF or any other similar name. In the disclosure, SMF may refer to the NF which provides the session management functions in the 6G network and can be interchangeably used with any other name for the same NF. Similarly for AMF, the AMF refers to a Network function in the 6G core network that is responsible for providing the Access and Mobility management functions.

The CU/CU-CP in the disclosed baseline architecture of the disclosure, as illustrated in FIG. 4, may also be designed to be a Network Function (NF), which is connected to the core network via the service-based interface. The general principles of NF service discovery, NF service registration and NF service authorization may apply to the CU-CP as well.

In an embodiment of the disclosure, for PDU session establishment in an end-to-end service-based environment, the UE transmits a non-access stratum (NAS) messages comprising PDU session establishment request to the CU-CP NF. The CU-CP NF is then configured to decode the NAS message received from the UE, or to receive decoded NAS message from an access and mobility management function (AMF) or a NAS decoder function (NDF) of the end-to-end service-based environment. Further the CU-CP NF is configured to select a session management function (SMF) based on the decoded NAS messages or receive an indication, from the AMF, indicative of a selected SMF. Subsequently the CU-CP NF receives the PDU session details from the selected SMF and sends the PDU session details to the UE, to facilitate the establishment of the PDU session.

To facilitate the above establishment of the PDU session in an end-to-end service-based architecture, the detailed explanation of the SMF selection in accordance with multiple embodiments of the disclosure is provided and the following solution(s) are hereby disclosed below:
1. SMF Selection by AMF with CU-CP NF assisted information.
2. SMF Selection by CU-CP NF.

SMF selection by CU-CP NF with AMF assisted, NAS message container decoding.

SMF selection by CU-CP NF using NAS functionality within RAN.

SMF selection by CU-CP NF with the assistance of a new network function for NAS message container decoding. (NAF: Network Assistance Function).

In an embodiment of the disclosure, the SMF selection in an end-to-end service-based architecture/environment is now discussed below.

1. SMF Selection by AMF with CU-CP NF Assisted Information

In the disclosure, it may be assumed that CU-CP NF and AMF are subscribed to each other using the existing service-based framework (NF subscribe/Notify) during the registration or after the AMF selection.

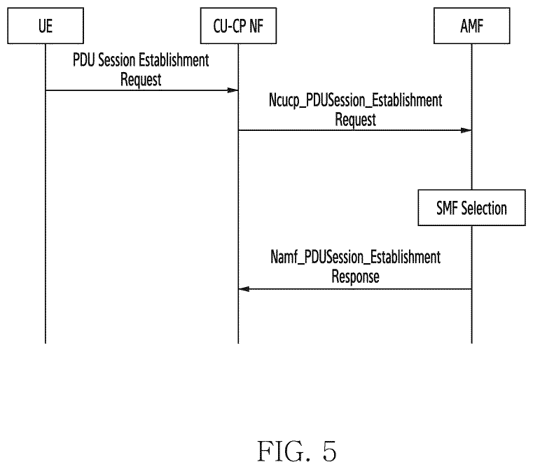

FIG. 5 illustrates a session establishment procedural call flow when the UE sends a request to the CU-CP NF according to an embodiment of the disclosure.

Referring to FIG. 5, when the UE sends the PDU session establishment request to the CU-CP NF, CU-CP NF may include the request information into a novel service operation “Ncucp_PDUSession_Establishment Request” and forwards it to the AMF for SMF selection at AMF.

The AMF may perform the SMF discovery and selection as per existing legacy procedures. After the SMF selection, the AMF may share the SMF information (e.g., SM context ID or selected SMF for PDU session) using the novel service operation “Namf_PDUSession_Establishment Response” and forwards it to the CU-CP NF for further communication between CU-CP NF and SMF for the PDU session.

In the subsequent sections, the disclosed CU-CP NF service and the novel service operation details are provided below.

| Service Name | Description |
|---|---|
| Ncucp_PDUSession_Establishment | CU-CP NF provides the information set to the |
| | AMF/any other NF consumer, which may be used |
| | by AMF for SMF selection. |
| Namf_PDUSession_Establishment | Using this AMF service operation, AMF provides |
| | the details of selected SMF/SMF Instance |
| | ID/SMF Context ID for the requested PDU |
| | session after SMF selection to the NF consumer. |

### Ncucp_PDUSession_Establishment

By this service operation the CU-CP NF provides the information set to the AMF/any other NF consumer, which may be used by AMF for SMF selection. The input required for this service operation may be S-NSSAI(s), UE Requested DNN,PDU Session ID, Request type, Old PDU Session ID,N1 SM container (PDU Session Establishment Request, [Port Management Information Container]),User Location Information (PLMN ID/TAI/geographical location), Access Type Information, CU-CP NF ID (CU-CP NF Profile info (IP address or FQDN)), UE to CU-CP NF mapping info (endpoint address or some Global Unique Identifier). PDU Session Establishment Request includes: PDU session ID, Requested PDU Session Type, Requested Session and Service Continuity (SSC) mode, UE's session management Capability, Protocol Configuration Options (PCO), Session management (SM) PDU Data Network (DN) Request Container, [Number Of Packet Filters], [Header Compression Configuration], UE Integrity Protection Maximum Data Rate, [Always-on PDU Session Requested], [Redundancy Sequence Number (RSN)], [Connection Capabilities] and [PDU Session Pair ID]. Further there may be no output required for this service operation.

### Namf_PDUSession_Establishment

Using this AMF service operation, AMF provides the details of selected SMF/SMF Instance ID/SMF Context ID for the requested PDU session after SMF selection to the NF consumer. There may be no input required for this service operation, however the output require may be selected SMF/SMF instance ID/SMF context ID.

In yet another embodiment of the disclosure, the SMF selection in an end-to-end service-based architecture/environment is now discussed below.

2(a). SMF Selection by CU-CP NF with AMF Assisted, NAS Message Container Decoding

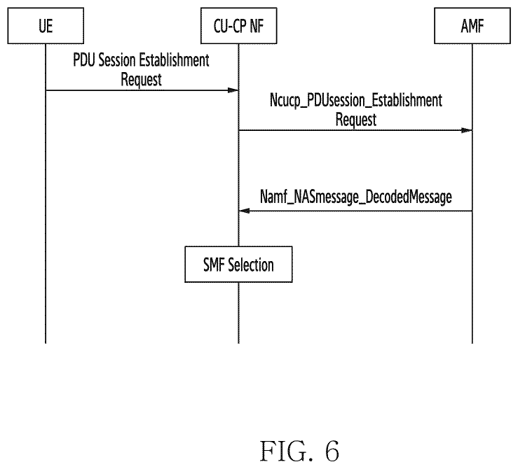

FIG. 6 illustrates the SMF selection by RAN NF (CU-CP NF) with AMF assisted when UE sends a request to the CU-CP NF according to an embodiment of the disclosure. In the disclosure, it is assumed that CU-CP NF and AMF are subscribed to each other using the existing service-based framework (NF subscribe/Notify) during the registration or after the AMF selection.

Referring to FIG. 6, when the UE sends the PDU session establishment Request to the CU-CP NF, CU-CP NF may include the request information into the novel service operation “Ncucp_PDUSession_Establishment Request” and forwards it to the AMF. As CU-CP NF may not be able to decode the NAS message containers from the UE (which are required for SMF selection at CU-CP NF), the AMF may help CU-CP NF in decoding the NAS messages and provide the decoded NAS messages to the CU-CP NF using the disclosed “Namf_NASmessage_DecodedMessage” service operation. After receiving the decoded NAS message container, using the information, CU-CP NF can select the SMF for PDU session establishment.

In the subsequent sections, the disclosed CU-CP NF service and the novel service operation details are provided.

### Ncucp_PDUSession_Establishment

Using this CU-CP NF service operation, CU-CP NF will provide the information set to the AMF/any other consumer NF, which will be used by AMF for SMF selection. The input required for this service operation may be S-NSSAI(s),UE Requested DNN,PDU Session ID, Request type, Old PDU Session ID,N1 SM container (PDU Session Establishment Request, [Port Management Information Container]), User Location Information (PLMN ID/TAI/geographical location), Access Type Information, CU-CP NF ID (CU-CP NF Profile info (IP address or FQDN)), UE to CU-CP NF mapping info (endpoint address or some Global Unique Identifier). PDU Session Establishment Request includes: PDU session ID, Requested PDU Session Type, Requested Session and Service Continuity (SSC) mode, UE's session management Capability, Protocol Configuration Options (PCO), Session management (SM) PDU Data Network (DN) Request Container, [Number Of Packet Filters], [Header Compression Configuration], UE Integrity Protection Maximum Data Rate, [Always-on PDU Session Requested], [Redundancy Sequence Number (RSN)], [Connection Capabilities] and [PDU Session Pair ID]. However, there is no output required for this service operation.

### Namf_NASmessage_DecodedMessage

Using this AMF service operation, AMF will provide the details of decoded NAS message container received in the Ncucp_PDUSession_Establishment message from CU-CP NF. The input required for this service operation may be NAS message container (S-NSSAI(s), UE Requested DNN, PDU Session ID, Request type, Old PDU Session ID,N1 SM container etc.). The output required may be decoded NAS message container.

Once CU-CP NF gets the decoded NAS message container details, CU-CP NF may perform the SMF discovery and selection for the PDU session, as explained below in the subsequent paragraphs.

### SMF Selection by CU-CP NF:

The SMF selection functionality is supported by the CU-CP NF and a Service Communication Proxy (SCP) may be used to allocate an SMF that may manage the PDU Session. If the CU-CP NF does discovery, the CU-CP NF may utilize the NRF to discover SMF instance(s) unless SMF information is available by other means, e.g., locally configured on CU-CP NF. The CU-CP NF provides the UE location information to the NRF when trying to discover SMF instance(s).

The NRF provides NF profile(s) of SMF instance(s) to the CU-CP NF. In addition, the NRF also provides the SMF service area of SMF instance(s) to the CU-CP NF. The SMF selection functionality in the CU-CP NF selects an SMF instance and an SMF service instance based on the available SMF instances obtained from NRF or on the configured SMF information in the CU-CP NF. The SMF selection functionality is applicable to both 3GPP access and non-3GPP access.

The following factors may be considered during the SMF selection:
a) Selected Data Network Name (DNN). In the case of the home routed roaming, the DNN is not applied for the V-SMF selection.
b) S-NSSAI of the HPLMN (for non-roaming and home-routed roaming scenarios), and S-NSSAI of the VPLMN (for roaming with local breakout and home-routed roaming scenarios).
c) NSI-ID. NOTE: The use of NSI-ID in the network is optional and depends on the deployment choices of the operator. If used, the NSI ID is associated with S-NSSAI.
d) Access technology being used by the UE.
e) Support for Control Plane cellular internet of things (CIoT) 6GS Optimisation.
f) Subscription information from UDM, e.g.
   per DNN: whether LBO roaming is allowed.
   per DNN: whether HR-SBO roaming is allowed.
   per S-NSSAI: the subscribed DNN(s).
   per (S-NSSAI, subscribed DNN): whether LBO roaming is allowed.
   per (S-NSSAI, subscribed DNN): whether HR-SBO roaming is allowed.
   per (S-NSSAI, subscribed DNN): whether EPC interworking is supported.
   per (S-NSSAI, subscribed DNN): whether selecting the same SMF for all PDU sessions to the same S-NSSAI and DNN is required.
   per (S-NSSAI, DNN) associated with 6G VN group: Service Area (LADN service area) for the 6G Virtual Network (VN) group. In the case of SMF selection for a PDU Session targeting 6G VN group, the CU-CP NF may prefer candidate SMF(s) that have an intersection with the LADN service area of the 6G VN group.
g) Local operator policies. NOTE: These policies can take into account whether the SMF to be selected is an I-SMF, a V-SMF, or a SMF.
h) Load conditions of the candidate SMFs.
i) Analytics (i.e., statistics or predictions) for candidate SMFs' load as received from network data analytics function (NWDAF), if NWDAF is deployed.
j) UE location (i.e., TA).
k) Service Area of the candidate SMFs.
l) Capability of the SMF to support a Multiple Access (MA) PDU Session.
m) If interworking with EPS/5G system (5GS)/6G system (6GS) is required.
n) Preference of V-SMF support. This is applicable only for V-SMF selection in the case of home routed roaming.
o) Target Data Network Access Identifier (DNAI).
p) Capability of the SMF to support User Plane Remote Provisioning
q) Supported Data Network Access Identifier (DNAI) list.
r) Home Routed with Session Breakout in VPLMN (HR-SBO) support
s) Capability of the SMF (V-SMF and H-SMF) to support non-3GPP access path switching.

To support the allocation of a static IPv4 address and/or a static IPv6 prefix, a dedicated SMF may be deployed for the indicated combination of DNN and S-NSSAI and registered to the NRF or provided by the UDM as part of the subscription data. In the case of delegated discovery, the CU-CP NF, may send all the available factors a)-d), j) and m) to the SCP. In addition, the CU-CP NF may indicate to the SCP which NRF to use (in the case of NRF dedicated to the target slice).

The SMF selection function is supported by the CU-CP NF and is used to allocate an SMF that manages the PDU Session. In this case the following two branches of deployment scenarios may be considered, which are explained in detail in the subsequent paragraphs. In an embodiment of the disclosure, the non-roaming and roaming with local breakout scenario is explained below.

1. Non-Roaming and Roaming with Local Breakout

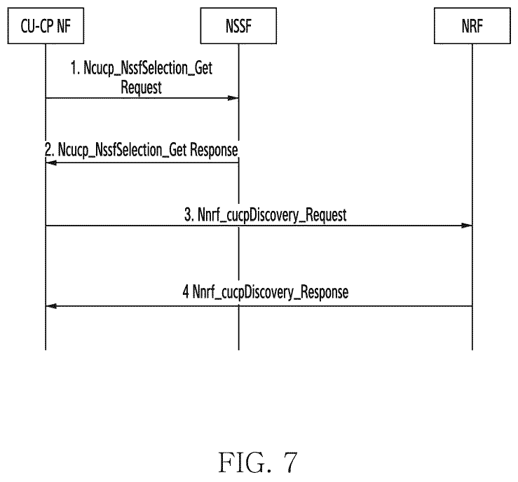

FIG. 7 illustrates SMF selection procedural call flow when the serving CU-CP NF is not aware of an appropriate NRF to be used to select NFs/services within the corresponding network slice instance (non-roaming and roaming with local breakout) according to an embodiment of the disclosure. This procedure may be skipped altogether if SMF information is available in the CU-CP NF by other means (e.g., locally configured).

When the serving CU-CP NF is aware of the appropriate NRF to be used to select NFs/services within the corresponding network slice instance based on configuration or based on the network slice selection information received during registration, only steps 3 and 4 in the following procedure are executed, as illustrated in FIG. 7.

When the serving CU-CP NF is not aware of the appropriate NRF to be used to select NFs/services within the corresponding network slice instance, all steps in the following procedure may be executed as illustrated in FIG. 7 and explained below.
At step 1. The CU-CP NF invokes the Ncucp_NssfSelection_Get Request service operation from the NSSF in serving PLMN with the S-NSSAI of the serving PLMN from the allowed NSSAI requested by the UE, PLMN ID of the SUPI, TAI of the UE and the indication that the request is within a procedure of PDU session establishment in either the non-roaming or roaming with local breakout scenario.
At step 2. The NSSF in serving PLMN selects the network slice instance, determines and returns the appropriate NRF to be used to select NFs/services within the selected network slice instance and optionally may return a NSI ID corresponding to the network slice instance using Ncucp_NssfSelection_Get Response service operation.
At step 3. The CU-CP NF queries the appropriate NRF in serving PLMN by issuing the Nnrf_cucpDiscovery_Request including at least the S-NSSAI of the Serving PLMN for this PDU session from the allowed NSSAI, PLMN ID of the SUPI, DNN and possibly NSI ID if the AMF has stored an NSI ID for the S-NSSAI of the serving PLMN for this PDU session from the allowed NSSAI.
At step 4. The NRF in serving PLMN provides to the CU-CP NF, e.g., FQDN or IP address, of a set of the discovered SMF instance(s) or Endpoint Address(es) of SMF service instance(s) in Nnrf_cucpDiscovery_Response message and possibly an NSI ID for the selected network slice instance corresponding to the S-NSSAI for subsequent NRF queries.

In the subsequent sections, the disclosed CU-CP NF service and the novel service operation details are provided.

### Ncucp_NssfSelection_Get

This service operation enables network slice selection in both the serving PLMN and HPLMN. When invoked during PDU session establishment procedure, it may be invoked in the VPLMN or in the HPLMN; if invoked in the VPLMN it requests the hNRF selected by the hNSSF and, if applicable, the value of the HPLMN NSI ID. If this service operation is invoked during PDU session establishment procedure in the serving PLMN, then the following inputs may be required: S-NSSAI, non-roaming/LBO roaming/HR roaming indication, PLMN ID of the SUPI, TAI, NF type of the NF service consumer, Requester ID. However, there is no output required for this service operation.

### Ncucp_NssfSelection_Get Response

Using this NSSF service operation, NSSF will provide the details of NRF to be used to select NFs/services within the selected Network Slice instance. There is no input required for this service operation, however if this service operation is invoked during PDU session establishment procedure, then the following outputs may be required: the NRF to be used to select NFs/services within the selected network slice instance.

### Nnrf_cucpDiscovery_Request

This service operation requests the IP address or FQDN of the expected NF instance(s) and, if present in NF profile, requests the Endpoint Address(es) of NF service instance(s) to the NF service consumer or SCP. The input required may be one or more target NF service Name(s), NF type of the target NF, NF type of the NF service consumer. However, no output is required in this service operation.

### Nnrf_cucpDiscovery_Response

This service operation provides the IP address or FQDN of the expected NF instance(s) and, if present in NF profile, the Endpoint Address(es) of NF service instance(s) to the NF service consumer or SCP. No input is required in this service operation, however the following output may be required: a set of NF instances, a validity period for the discovery result, containing per NF Instance: NF type, NF instance ID, FQDN or IP address(es) of the NF instance and if applicable, a list of services instances, where each service instance has a service name, a NF service instance ID and optionally Endpoint Address(es). Endpoint Address(es) may be a list of IP addresses or an FQDN for the NF service instance.

In yet another embodiment of the disclosure, the home routed roaming scenario is explained below. The home routed roaming may be further divided into two options. The first option of the home routed roaming is explained below.

### 2. Home Routed Roaming: Option 1

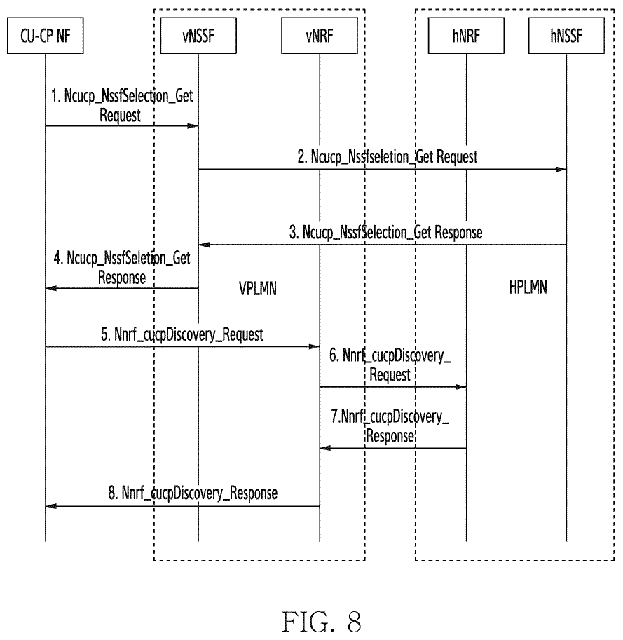

FIG. 8 illustrates the steps of SMF selection procedural call flow when the serving CU-CP NF is not aware of an appropriate NRF to be used to select NFs/services within the corresponding network slice instance (Home routed roaming) according to an embodiment of the disclosure. All steps in the following procedure may be executed as illustrated in FIG. 8 and explained below.
At step 1. Based on the operator's configuration, if the CU-CP NF is not aware of the appropriate NRF to be used to select NFs/services in the HPLMN, the CU-CP NF invokes the Ncucp_NssfSelection_Get Request service operation from the NSSF in VPLMN with the VPLMN S-NSSAI from the Allowed NSSAI requested by the UE for this PDU Session. The HPLMN S-NSSAI that maps to the VPLMN S-NSSAI, PLMN ID of the SUPI, the TAI of the UE and the indication that the request is within a procedure of PDU session establishment in the home-routed roaming scenario.
At step 2. If slicing configuration information for the S-NSSAI in the HPLMN is not available (e.g., the NSSF has no cached information), the NSSF of the VPLMN invokes the Ncucp_NssfSelection_Get Request service operation from NSSF of the HPLMN according to the PLMN ID of SUPI by including the HPLMN S-NSSAI.
At step 3. The NSSF in HPLMN may include the NSI ID, if needed, for the network slice instance in HPLMN selected for the corresponding S-NSSAI of the HPLMN in the Ncucp_NssfSelection_Get Response. The NSSF in HPLMN also includes the appropriate hNRF to be used to select NFs/services within HPLMN in the Ncucp_NssfSelection_Get response.
At step 4. The serving NSSF includes in the Ncucp_NssfSelection_Get Response, all the information that has been received from the NSSF in HPLMN when responding to the CU-CP NF.
At step 5. The CU-CP NF queries the target vNRF using the service operation Nnrf_cucpDiscovery_Request by including PLMN ID of the SUPI, DNN, HPLMN S-NSSAI, the hNRF and possibly an HPLMN NSI ID for the selected network slice instance corresponding to the HPLMN S-NSSAI if available in the CU-CP NF (obtained from the HPLMN NSSF in steps 3 and 4 or cached from a previous H-NSSF query).
At step 6. The NRF in serving PLMN identifies NRF in HPLMN (hNRF) based on the information provided by the NSSF in the serving PLMN and it invokes the Nnrf_cucpDiscovery_Request service from hNRF to get the expected SMF instance(s) deployed in the HPLMN. As the vNRF in VPLMN triggers the “NF Discovery” on behalf of the CU-CP NF, the NRF in the VPLMN may not replace the information of the NF, i.e., CU-CP NF ID, in the Nnrf_cucpDiscovery_Request message it sends to the hNRF.
At step 7-8. The hNRF provides to the CU-CP NF, via vNRF, the information e.g., FQDN or IP address, of a set of the SMF instance(s) in Nnrf_cucpDiscovery_Response message and possibly an NSI ID for the selected network slice instance corresponding to the S-NSSAI of the HPLMN for subsequent NRF queries.

In another embodiment of the disclosure, the second option of the home routed roaming is explained below.

### 2. Home Routed Roaming: Option 2

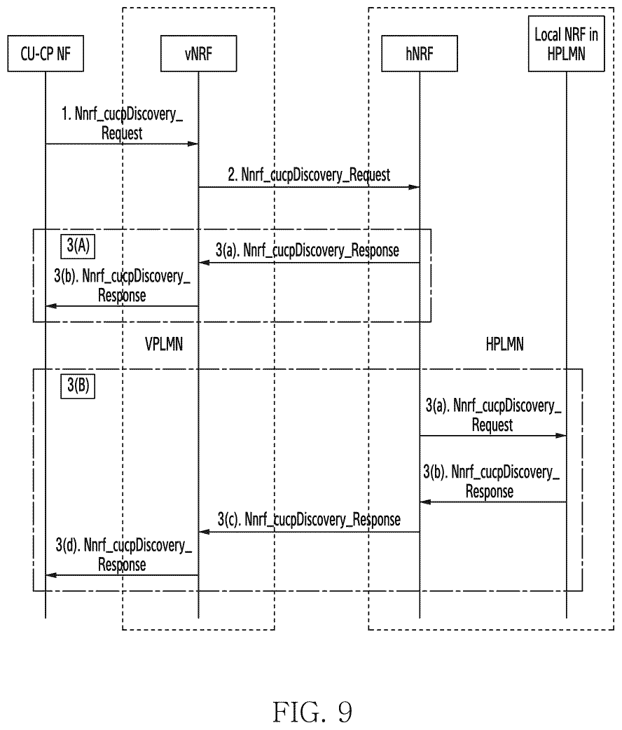

FIG. 9 illustrates SMF the steps of selection procedural call flow (Home routed roaming with option 2) according to an embodiment of the disclosure. All steps in the following procedure may be executed as illustrated in FIG. 9 and explained below.
At step 1. Based on the operator's configuration, the CU-CP NF queries the vNRF with PLMN ID of the SUPI, PLMN ID of the serving PLMN, DNN, the HPLMN S-NSSAI that maps to the S-NSSAI from the allowed NSSAI of the serving PLMN the UE has requested, the hNRF and, if applicable and available, an HPLMN NSI ID (if the AMF has stored an hNRF and, if applicable and available, an HPLMN NSI ID for the selected network slice instance corresponding to the S-NSSAI of the HPLMN) and DNN using Nnrf_cucpDiscovery_Request service operation.
At step 2. The vNRF queries, on behalf of the CU-CP in VPLMN, the hNRF identified by means of the PLMN ID of the SUPI (if no hNRF is received from the CU-CP NF, the hNRF is locally determined in the vNRF based on information received in step 1). The NRF in VPLMN requests “NF Discovery” service from hNRF to get the expected SMF instance(s) deployed in the HPLMN. As the NRF in the serving PLMN triggers the “NF Discovery” on behalf of the CU-CP NF, the NRF in the VPLMN may not replace the information of the NF, i.e., CU-CP NF ID, in the Nnrf_cucpDiscovery_Request message it sends to the hNRF.

Further, depending on the available information and based on configuration, the hNRF may either execute steps in 3(A) or in 3(B).
At step 3(A). The hNRF provides to the CU-CP NF, via vNRF, the information e.g., FQDN or IP address, of a set of the discovered SMF instance(s) and possibly an NSI ID for the selected HPLMN part of the network slice instance corresponding to the S-NSSAI of the HPLMN for subsequent NRF queries in Nnrf_cucpDiscovery_Response message (steps 3(a) and 3(b) in FIG. 9).
At step 3(B). The hNRF queries, on behalf of the CU-CP NF, an appropriate local NRF in HPLMN (e.g. a slice level NRF); this local NRF provides the IP address or the FQDN of expected SMF instance(s) and possibly an NSI ID for the selected HPLMN part of the network slice instance corresponding to the S-NSSAI of the HPLMN for subsequent NRF queries (steps 3(a) and 3(b) in FIG. 9) that the hNRF returns, via vNRF, to the CU-CP NF (steps 3(c) and 3(d) in FIG. 9).

In yet another embodiment of the disclosure, the SMF selection in an end-to-end service-based architecture/environment is now discussed below.

2(b). SMF Selection by CU-CP NF Using NAS Functionality within RAN

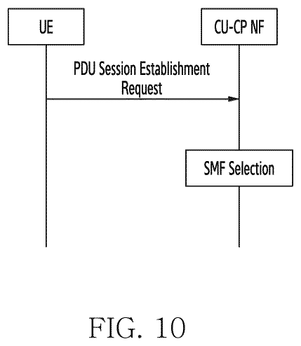

FIG. 10 illustrates SMF Selection by RAN (CU-CP NF) using NAS functionality within RAN, according to an embodiment of the disclosure. In the disclosure, it is assumed that CU-CP NF and AMF are subscribed to each other using the existing service-based framework (NF subscribe/Notify) during the registration or after the AMF selection. In addition, CU-CP NF has the NAS message decoding capability within the RAN itself

Referring to FIG. 10, when the UE sends the PDU session establishment Request to the CU-CP NF, CU-CP NF will directly perform the SMF discovery and selection procedure as described above.

In yet another embodiment of the disclosure, the SMF selection in an end-to-end service-based architecture/environment is now discussed below.

2(c). SMF Selection by CU-CP NF with the Assistance of a New Network Function for NAS Message Container Decoding (NDF: NAS Decode Function)

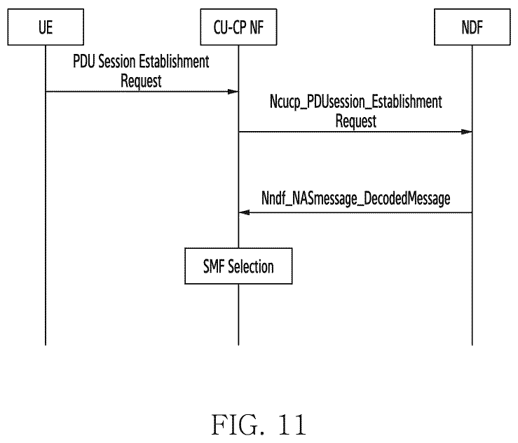

FIG. 11 illustrates SMF Selection by CU-CP NF using a new network function for NAS container decoding, according to an embodiment of the disclosure. In the disclosure, it is assumed that the CU-CP NF and AMF are subscribed to each other using the existing service-based framework (NF subscribe/Notify) during the registration or after the AMF selection.

Referring to FIG. 11, when the UE sends the PDU session establishment Request to the CU-CP NF, CU-CP NF may include the request information into the novel service operation Ncucp_PDUSession_Establishment and forwards it to the novel NF, i.e., NAS Decode Function (NDF).

NDF is a new NF, which may be used by any NF consumer (here, CU-CP NF) to get the decoded NAS messages.

As CU-CP NF may not be able to decode the NAS message containers from the UE (which are required for SMF selection at CU-CP NF), NDF may help CU-CP NF in decoding the NAS messages and provide the decoded NAS messages to the CU-CP NF using the disclosed Nndf_NASmessage_DecodedMessage service operation.

Once the decoded NAS container information is available to CU-CP NF, CU-CP NF will directly perform the SMF discovery and selection procedure as described in previous embodiments of the disclosure.

Ncucp_Communication_SessionEstablishment Request service operation details are described earlier.

Ncucp_PDUSession_Establishment service operation details are already described in solution 2(a) and FIG. 11.

In the subsequent sections, the disclosed NDF NF service operation and the novel service operation details are provided.

### Nndf_NASmessage_DecodedMessage

Using this new NDF NFs service operation, NDF will provide the details of decoded NAS message container received in the Ncucp_PDUSession_Establishment message from CU-CP NF. The input required for this service operation may be NAS message container (S-NSSAI(s), UE Requested DNN, PDU Session ID, Request type, Old PDU Session ID, N1 SM container etc.). The output required may be decoded NAS message container.

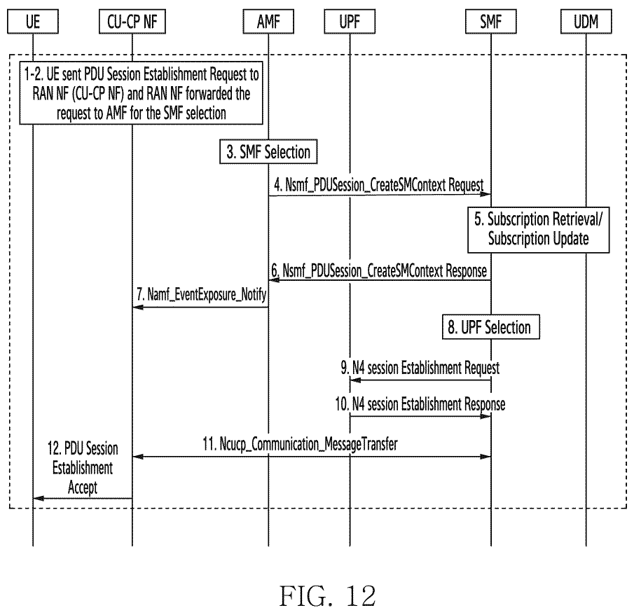

FIG. 12 illustrates a PDU session establishment when AMF performs SMF selection, according to an embodiment of the disclosure.

Referring to FIG. 12, in Steps 1 and 2, the CU-CP NF and the AMF are subscribed to each other using the existing service-based framework (NF subscribe/Notify) during the registration or after the AMF selection.

According to an embodiment, as per FIG. 12, when the UE sends the PDU session establishment Request to the CU-CP NF, the CU-CP NF may forward the request information to the AMF for the SMF selection at the AMF (maybe through the service-based interface or via any existing interface). FIG. 12 may perform the process steps as disclosed below.
At step 3: The AMF may perform the SMF discovery and selection as per existing legacy procedures.
At step 4: After the SMF selection at step 3, if the AMF does not have an association with an SMF for the PDU session ID provided by the UE (e.g., when request type is “Initial Request), the AMF may invoke the Nsmf_PDUSession_CreateSMContext Request else, AMF will invoke Nsmf_PDUSession_CreateSMContext Request (for request type “Existing PDU session”).
At step 5: While creating an association between the SMF and the AMF, the SMF may also get/update the subscription data from a UDM or a PCF (using the existing framework between SMF and UDM or PCF).
At step 6: Nsmf_PDUSession_CreateSMContext Request creates an AMF-SMF association to support a PDU Session. In response, the SMF provides the SMF context ID/SMF ID/SMF related information to the AMF using Nsmf_PDUSession_CreateSMContext Response.
At step 7: As CU-CP NF is subscribed to the AMF (maybe during Registration or AMF selection), the AMF may provide the SMF information (SMF context ID/SMF ID/SMF related information) to the CU-CP NF using novel AMF's service Operation Namf_EventExposure_Notify.
At step 8: After step 7, the SMF may perform the existing UPF selection procedure to select the UPF for the PDU session.
At step 9: The SMF will set up the tunnel with the UPF using existing procedures (N4 session Establishment Request and N4 session Establishment Response).
At step 10: Using N4 session establishment the SMF gets the GTP tunnel info from the UPF.
At step 11: After the successful creation of the Tunnel endpoint, the SMF sends a novel RAN NF service operation Ncucp_Communication_MessageTransfer with Tunnel Details and PDU session details to the CU-CP NF.
At step 12: The CU-CP NF forwards the PDU session details (N1 SM container) to the UE, which carries the PDU Session Establishment Accept. After step 12, the PDU session is established between the SMF and the CU-CP NF.

According to one or more embodiments, the new input IE additions to the existing service operation are described below:

### Nsmf_PDUSession_CreateSMContext Request

This service operation comprises SUPI, selected DNN, UE requested DNN, S-NSSAI(s), PDU Session ID, AMF ID, Request Type, [PCF ID, Same PCF Selection Indication], Priority Access, [Small Data Rate Control Status], N1 SM container (PDU Session Establishment Request), User location information, Access Type, RAT Type, PEI, GPSI, UE presence in LADN service area, Subscription For PDU Session Status Notification, DNN Selection Mode, Trace Requirements, Control Plane CIoT 6GS Optimisation indication, Control Plane Only indicator, Satellite backhaul category, GEO Satellite ID, [PVS FQDN(s) and/or PVS IP address(es), Onboarding Indication], Disaster Roaming service indication, CU-CP NF ID (CU-CP NF Profile info (IP address or FQDN)), UE to CU-CP NF mapping info (endpoint address or some Global Unique Identifier). The reason to add the new IE's is further explained below.

In the disclosure it is assumed that RAN may be service-based, hence RAN NF ID (CU-CP NF ID) is required for direct communication between the SMF and the RAN NF. In addition, the UE to the CU-CP NF mapping info is required for the transmission of messages from the SMF to the UE (via the CU-CP NF).

### Namf_EventExposure_Notify

This service operation is used to provide the event-based notifications to the subscribed consumer NFs. In the disclosure context, this will include SMF context ID/SMF ID/SMF related information. The reason to add the new IE's is that after SMF selection at AMF, AMF needs to notify the selected SMF details to RAN NF for PDU session establishment and direct communication between RAN NF and SMF.

According to one or more embodiments, details corresponding to CU-CP NF service operation Ncucp_Communication_MessageTransfer are described below.

| Service Name | Description |
|---|---|
| Ncucp_Communication | Enables an NF consumer to communicate |
| | with the RAN NF (CU-CP NF) directly |

| | Service | Operation | Known |
|---|---|---|---|
| Service Name | Operations | Semantic | Consumer(s) |
| Ncucp_Communication | MessageTransfer | Request/Response | SMF, |
| | | | SMSF, |
| | | | PCF, AMF |
| | | | etc. |

### Ncucp_Communication_MessageTransfer

This service operation is used to transfer downlink or uplink messages between the RAN NF (CU-CP NF) and the consumer NF. The input required for this service operation may be PDU Session ID, N2 SM information (For RAN) (PDU Session ID, QFI(s), QoS Profile(s), CN Tunnel Info, S-NSSAI from the Allowed NSSAI, Session-AMBR, PDU Session Type, User Plane Security Enforcement information, UE Integrity Protection Maximum Data Rate, RSN, PDU Session Pair ID, TL-Container), N1 SM container (For UE). The output required may be the result indication.

All other depicted service operations in the solution (FIG. 12), will use the existing parameters to transfer messages/parameters/containers between the NFs.

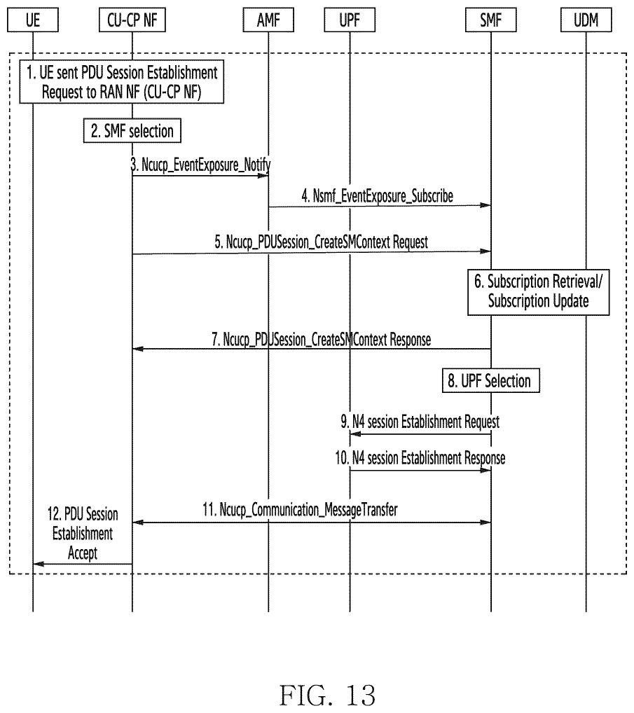

FIG. 13 illustrates a PDU session establishment when CU-CP NF performs the SMF selection, according to an embodiment of the disclosure. According to an embodiment, CU-CP NF and AMF may be subscribed to each other using the existing service-based framework (NF subscribe/Notify) during the registration or after the AMF selection.

Referring to FIG. 13, a series of method steps for this solution is provided below.
At step 1: The UE sends the PDU session establishment Request to the CU-CP NF.
At step 2: The CU-CP NF performs the SMF discovery and selection.
At step 3: After the SMF selection, the CU-CP NF notifies the details of the selected SMF to the AMF using the CU-CP NF service operation Ncucp_EventExposure_Notify.
At step 4: Once the AMF gets the SMF details from the CU-CP NF, the AMF subscribes to the SMF using the existing SMF service operation Nsmf_EventExposure_Subscribe.
At step 5: After the SMF selection, if the CU-CP NF does not have an association with the SMF for the PDU session ID provided by the UE (e.g. when request type is “Initial Request), the CU-CP NF will invoke the novel CU-CP NF service operation Ncucp_PDUSession_CreateSMContext Request else CU-CP NF will invoke Ncucp_PDUSession_CreateSMContext Request (for request type “Existing PDU session”) for establishing the RAN-SMF association for the PDU session.
At step 6: While creating an association between the SMF and the CU-CP NF, the SMF can also get/update the subscription data from the UDM or PCF (using an existing framework between SMF and UDM or PCF).
At step 7: Ncucp_PDUSession_CreateSMContext Request creates an CU-CP NF-SMF association to support a PDU Session. In response, the SMF provides the SMF context ID/SMF ID/SMF related information to the CU-CP NF using Ncucp_PDUSession_CreateSMContext Response.
At step 8: Thereafter, the SMF performs the existing UPF selection procedure to select the UPF for the PDU session.
At step 9: The SMF sets up the tunnel with the UPF using existing procedures (N4 session Establishment Request and N4 session Establishment Response).
At step 10: Using N4 session establishment the SMF gets the GTP tunnel info from the UPF.
At step 11: After the Successful creation of a Tunnel endpoint, the SMF sends the novel CU-CP NF service operation Ncucp_Communication_MessageTransfer with Tunnel Details and PDU session details to the CU-CP NF.
At step 12: The CU-CP NF forwards the PDU session details (N1 SM container) to the UE, which carries the PDU Session Establishment Accept. After step 12, the PDU session is established between the SMF and the CU-CP NF.

According to one or more embodiments, details corresponding to CU-CP NF service operation Ncucp_EventExposure_Notify are disclosed below.

| Service Name | Description |
|---|---|
| Ncucp_EventExposure | Enables other NF consumers to subscribe or get |
| | notified about the NF Info. |

| | Service | Operation | Known |
|---|---|---|---|
| Service Name | Operations | Semantic | Consumer(s) |
| Ncucp_EventExposure | Notify | Subscribe/Notify | SMF, |
| | | | SMSF, |
| | | | PCF, AMF |
| | | | etc. |

### Ncucp_EventExposure_Notify

This service operation is used to report CU-CP NF related event(s) to the NF which has subscribed to the event report service. (Here the selected SMF details). The input required for this service operation may be the selected AMF ID. The output required may be the SMF ID/SMF related information.

According to one or more embodiments, details corresponding to CU-CP NF service operation Ncucp_PDUSession_CreateSMContext Request are described below.

| Service Name | Description |
|---|---|
| Ncucp_PDUSession | This service manages the PDU Sessions and |
| | uses the policy and charging rules |
| | received from the PCF. The service |
| | operations exposed by this NF service |
| | allow the consumer NFs to handle |
| | the PDU Sessions. |

| | Service | Operation | Known |
|---|---|---|---|
| Service Name | Operations | Semantic | Consumer(s) |
| Ncucp_PDUSession | CreateSMContext | Request/Response | SMF |

### Ncucp_PDUSession_CreateSMContext Request

This service operation creates an RAN NF-SMF association to support a PDU Session. The input required for this service operation may be SUPI, selected DNN, UE requested DNN, S-NSSAI(s), PDU Session ID, AMF ID, Request Type, [PCF ID, Same PCF Selection Indication], Priority Access, [Small Data Rate Control Status], N1 SM container (PDU Session Establishment Request), User location information, Access Type, RAT Type, PEI, GPSI, UE presence in LADN service area, Subscription For PDU Session Status Notification, DNN Selection Mode, Trace Requirements, Control Plane CIoT 6GS Optimisation indication, Control Plane Only indicator, Satellite backhaul category, GEO Satellite ID, [PVS FQDN(s) and/or PVS IP address(es), On boarding Indication], Disaster Roaming service indication, CU-CP NF ID (CU-CP NF Profile info (IP address or FQDN)), UE to CU-CP NF mapping info (endpoint address or some Global Unique Identifier). However, no output may be required for this service operation.

According to one or more embodiments, details corresponding to CU-CP NF service operation Ncucp_PDUSession_CreateSMContext Response are described below.

| Service Name | Description |
|---|---|
| Ncucp_PDUSession | This service manages the PDU Sessions |
| | and uses the policy and charging rules |
| | received from the PCF. The service |
| | operations exposed by this NF service |
| | allow the consumer NFs to handle |
| | the PDU Sessions. |

| | Service | Operation | Known |
|---|---|---|---|
| Service Name | Operations | Semantic | Consumer(s) |
| Ncucp_PDUSession | CreateSMContext | Request/Response | SMF |

### Ncucp_PDUSession_CreateSMContext Response

This service operation creates an RAN NF-SMF association to support a PDU Session. No input may be required for this service operation. However, the output required may be SMF context ID/SMF ID/SMF related information.

All other depicted service operations in the solution (FIG. 13), will use the existing parameters to transfer messages/parameters/containers between the NFs.

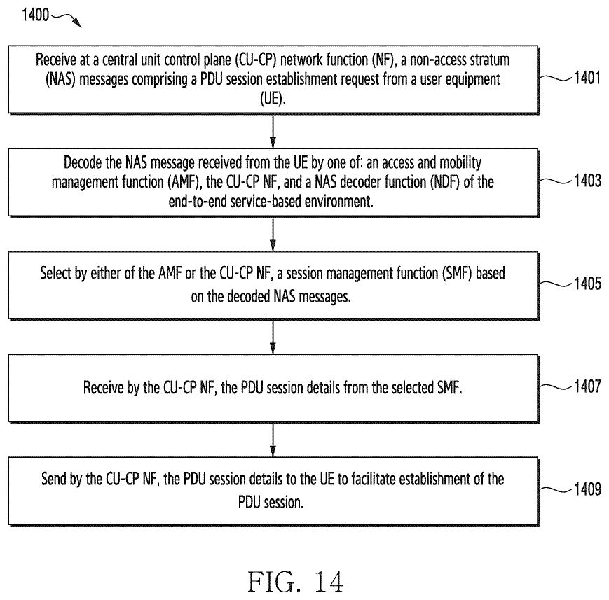

FIG. 14 illustrates a method for PDU session establishment in an end-to-end service-based environment, according to an embodiment of the disclosure. Although example method 1400 depicts a particular sequence of operations, the sequence may be altered without departing from the scope of the disclosure. For example, some of the operations depicted may be performed in parallel or in a different sequence that does not materially affect the function of method 1400.

According to some examples, at operation1401 method 1400 includes receiving at a central unit control plane (CU-CP) network function (NF), a non-access stratum (NAS) messages comprising a PDU session establishment request from a user equipment (UE). At operation 1403, method 1400 includes decoding the NAS message received from the UE by one of: an access and mobility management function (AMF), the CU-CP NF, and a NAS decoder function (NDF) of the end-to-end service-based environment. At operation 1405, method 1400 includes selecting by either of the AMF or the CU-CP NF, a session management function (SMF) based on the decoded NAS messages. At operation 1407, method 1400 includes receiving by the CU-CP NF, the PDU session details from the selected SMF. At operation 1409, method 1400 includes sending by the CU-CP NF, the PDU session details to the UE to facilitate establishment of the PDU session.

In another embodiment, the method of decoding the NAS message received from the UE by the AMF or the NDF comprises sending, by the CU-CP NF, the NAS message comprising the PDU session establishment request to the AMF or the NDF via Ncucp_PDUSession_Establishment Request, and decoding the NAS message by the AMF or the NDF. The NDF is a network function used by any NF consumer to get decoded NAS messages.

In another embodiment, the method of decoding the NAS message received from the UE by the AMF or the NDF further comprise sending by the AMF or the NDF, the decoded NAS messages to the CU-CP NF using Nndf_NASmessage_DecodedMessage.

In another embodiment, the CU-CP NF supports SMF selection in a non-roaming and roaming with local breakout condition and home routed roaming condition.

In another embodiment, in case of the SMF selection in the non-roaming and roaming with local breakout condition, the method for selecting the SMF based on the decoded NAS messages by the CU-CP NF comprises determining whether SMF information is available in the CU-CP NF via local configurations.

In another embodiment, the method may further comprise, selecting by the CU-CP NF, the SMF based on the local configurations, when the SMF information is available in the CU-CP NF via the local configurations,

In another embodiment, the method when the SMF information is unavailable in the CU-CP NF via local configurations and when the serving CU-CP NF is aware of an appropriate network repository function (NRF), the method may further comprise querying, by the CU-CP NF, the NRF in a serving public land mobile network (PLMN) using Nnrf_cucpDiscovery_Request. The Nnrf_cucpDiscovery_Request comprises at least a single network slice selection assistance information (S-NSSAI) of the serving PLMN, PLMN ID of subscription permanent identifier (SUPI), data network name (DNN), and network slice instance (NSI) ID if the AMF has stored an NSI ID for the S-NSSAI of the serving PLMN for the PDU session from allowed NSSAI. The method may further comprise receiving, by the CU-CP NF from the NRF, fully qualified domain name (FQDN) or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In another embodiment, the method when the SMF information is unavailable in the CU-CP NF via local configurations and when the serving CU-CP NF is unaware of an appropriate NRF, the method comprises invoking Ncucp_NssfSelection_Get service operation from a network slice selection function (NSSF) in a serving PLMN with S-NSSAI of the serving PLMN from allowed NSSAI requested by the UE, with PLMN ID of SUPI, tracking area identity (TAI) of the UE, and an indication of the PDU Session establishment being either from non-roaming or roaming with local breakout scenario. The method may further comprise receiving, form the NSSF in serving PLMN, information of the NRF to be used to select NFs/services within a selected Network Slice instance. The method may further comprise querying, by the CU-CP NF, the NRF in serving PLMN using Nnrf_cucpDiscovery_Request, the Nnrf_cucpDiscovery_Request comprises at least S-NSSAI of the serving PLMN for the PDU Session from allowed NSSAI, PLMN ID of SUPI, DNN and NSI ID if the AMF has stored an NSI ID for the S-NSSAI of the serving PLMN for the PDU session from the allowed NSSAI. The method may further comprise receiving, by the CU-CP NF from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In another embodiment, in case of the SMF selection in home routed roaming condition, the method for selecting the SMF based on the decoded NAS messages by the CU-CP NF may comprise determining whether the CU-CP NF is aware of a NRF to be used to select NFs/services in HPLMN.

In another embodiment, the method when the CU-CP NF is unaware of the NRF to be used to select the NFs/services in the HPLMN, may comprise invoking the Ncucp_NssfSelection_Get Request service operation from the NSSF in a VPLMN with a VPLMN S-NSSAI, a HPLMN S-NSSAI, a PLMN ID of the SUPI, a TAI of the UE, and an indication that PDU Session establishment is in the home-routed roaming condition. The method may further comprise receiving, from the NSSF in the VPLMN, information of a vNRF to be used to select NFs/services. The method may further comprise querying the NRF via Nnrf_cucpDiscovery_Request, and receiving, by the CU-CP NF from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In other embodiment, the method upon selection of the SMF by the AMF may further comprise determining, by the AMF, whether the AMF have an association with any SMF for the PDU session ID provided by the UE. The method may further comprise sending, by the AMF, Nsmf_PDUSession_CreateSMContext Request to the selected SMF. The Nsmf_PDUSession_CreateSMContext Request creates an AMF-SMF association to support the PDU session, when an association of the AMF with any SMF is unavailable. The method may further comprise receiving, by the AMF, at least one of SMF context ID, SMF ID, and SMF related information of the selected SMF via Nsmf_PDUSession_CreateSMContext Response from the selected SMF, sending, by the AMF, at least one of the SMF context ID, the SMF ID, and the SMF related information of the selected SMF to the CU-CP NF, and receiving, by the CU-CP NF, the PDU session details via Ncucp_Communication_MessageTransfer from the selected SMF.

In other embodiment, the method upon selection of the SMF by the CU-CP NF may further comprise sending, by the CU-CP NF, details of the selected SMF to the AMF via Ncucp_EventExposure_Notify. The method may further comprise subscribing, by the AMF, to the selected SMF via using Nsmf_EventExposure_Subscribe service operation upon receiving the SMF details from the CU-CP NF. The method may further comprise sending, by the CU-CP NF, Ncucp_PDUSession_CreateSMContext Request to the selected SMF. The Ncucp_PDUSession_CreateSMContext Request creates an CU-CP-SMF association to support the PDU session, when an association of the CU-CP NF with any SMF is unavailable, receiving, by the CU-CP NF, at least one of SMF context ID, SMF ID, and SMF related information of the selected SMF via Ncucp_PDUSession_CreateSMContext Response from the selected SMF, and receiving, by the CU-CP NF, the PDU session details via Ncucp_Communication_MessageTransfer from the selected SMF.

According to embodiments, a method may be performed by a central unit control plane (CU-CP) network function (NF) for PDU session establishment in an end-to-end service-based environment. The method may comprise receiving, from a user equipment (UE), a non-access stratum (NAS) message comprising a PDU session establishment request. The method may comprise obtaining a decoded NAS message in response to receiving the NAS message. The method may comprise selecting a session management function (SMF) based on the decoded NAS message. The method may comprise receiving, from the selected SMF, PDU session details. The method may comprise transmitting, to the UE, the PDU session details to facilitate an establishment of the PDU session.

In an embodiment, obtaining the decoded NAS message comprises transmitting, to an access and mobility management function (AMF), the NAS message comprising the PDU session establishment request and receiving, from the AMF, the decoded NAS message.

In an embodiment, obtaining the decoded NAS message comprises transmitting, to a NAS decoder function (NDF), the NAS message comprising the PDU session establishment request and receiving, from the NDF, the decoded NAS message.

In an embodiment, the CU-CP NF supports a SMF selection in a non-roaming and roaming with local breakout condition and home routed roaming condition.

In an embodiment, in case of a SMF selection in a non-roaming and roaming with local breakout condition, selecting the SMF based on the decoded NAS message comprises determining whether SMF information is available in the CU-CP NF via local configurations.

In an embodiment, the method further comprises selecting the SMF based on the local configurations, when the SMF information is available in the CU-CP NF via the local configurations.

In an embodiment, when the SMF information is unavailable in the CU-CP NF via the local configurations and when the CU-CP NF is aware of a network repository function (NRF), the method comprises querying, the NRF in a serving public land mobile network (PLMN) using Nnrf_cucpDiscovery_Request, wherein the Nnrf_cucpDiscovery_Request comprises at least a single network slice selection assistance information (S-NSSAI) of the serving PLMN, PLMN ID of subscription permanent identifier (SUPI), data network name (DNN), and network slice instance (NSI) ID if an AMF has stored an NSI ID for the S-NSSAI of the serving PLMN for the PDU session from allowed NSSAI. wherein when the SMF information is unavailable in the CU-CP NF via the local configurations and when the CU-CP NF is aware of a network repository function (NRF), the method comprises receiving, from the NRF, fully qualified domain name (FQDN) or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In an embodiment, when the SMF information is unavailable in the CU-CP NF via the local configurations and when the CU-CP NF is unaware of a network repository function (NRF), the method comprises invoking Ncucp_NssfSelection_Get service operation from a network slice selection function (NSSF) in a serving PLMN with S-NSSAI of the serving PLMN from allowed NSSAI requested by the UE, with PLMN ID of SUPI, tracking area identity (TAI) of the UE, and an indication of the PDU Session establishment being either from non-roaming or roaming with local breakout scenario. when the SMF information is unavailable in the CU-CP NF via the local configurations and when the CU-CP NF is unaware of a network repository function (NRF), the method comprises receiving, form the NSSF in serving PLMN, information of an NRF to be used to select NFs/services within a selected Network Slice instance. when the SMF information is unavailable in the CU-CP NF via the local configurations and when the CU-CP NF is unaware of a network repository function (NRF), the method comprises querying the NRF in serving PLMN using Nnrf_cucpDiscovery_Request, wherein the Nnrf_cucpDiscovery_Request comprises at least S-NSSAI of the serving PLMN for the PDU Session from allowed NSSAI, PLMN ID of SUPI, DNN and NSI ID if the AMF has stored an NSI ID for the S-NSSAI of the serving PLMN for the PDU session from the allowed NSSAI. when the SMF information is unavailable in the CU-CP NF via the local configurations and when the CU-CP NF is unaware of a network repository function (NRF), the method comprises receiving, from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In an embodiment, in case of the SMF selection in home routed roaming condition, selecting the SMF based on the decoded NAS message comprises determining whether the CU-CP NF is aware of a NRF to be used to select NFs/services in HPLMN.

In an embodiment, when the CU-CP NF is unaware of the NRF to be used to select the NFs/services in the HPLMN, the method comprises invoking the Ncucp_NssfSelection_Get Request service operation from the NSSF in a VPLMN with a VPLMN S-NSSAI, a HPLMN S-NSSAI, a PLMN ID of the SUPI, a TAI of the UE, and an indication that PDU Session establishment is in the home-routed roaming condition. When the CU-CP NF is unaware of the NRF to be used to select the NFs/services in the HPLMN, the method comprises receiving, from the NSSF in the VPLMN, information of a vNRF to be used to select NFs/services. When the CU-CP NF is unaware of the NRF to be used to select the NFs/services in the HPLMN, the method comprises querying the NRF via Nnrf_cucpDiscovery_Request. When the CU-CP NF is unaware of the NRF to be used to select the NFs/services in the HPLMN, the method comprises receiving, from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In an embodiment, upon selection of the SMF by the CU-CP NF, the method comprises transmitting, to the selected SMF, Ncucp_PDUSession_CreateSMContext Request, wherein Ncucp_PDUSession_CreateSMContext Request creates an CU-CP-SMF association to support the PDU session, when an association of the CU-CP NF with any SMF is unavailable. The method comprises receiving, from the selected SMF, at least one of SMF context ID, SMF ID, and SMF related information of the selected SMF via Ncucp_PDUSession_CreateSMContext Response. The method comprises receiving, from the selected SMF, the PDU session details via Ncucp_Communication_MessageTransfer.

According to embodiments, a central unit control plane (CU-CP) network function (NF) for PDU session establishment in an end-to-end service-based environment comprises communication circuitry. The CU-CP NF comprises at least one processor including processing circuitry. The CU-CP NF comprises memory, including one or more storage media, storing instructions. The instructions, when executed by the at least one processor individually or collectively, cause the CU-CP NF to receive, from a user equipment (UE), a non-access stratum (NAS) message comprising a PDU session establishment request. The instructions, when executed by the at least one processor individually or collectively, cause the CU-CP NF to obtain a decoded NAS message in response to receiving the NAS message. The instructions, when executed by the at least one processor individually or collectively, cause the CU-CP NF to select a session management function (SMF) based on the decoded NAS message. The instructions, when executed by the at least one processor individually or collectively, cause the CU-CP NF to receive, from the selected SMF, PDU session details. The instructions, when executed by the at least one processor individually or collectively, cause the CU-CP NF to transmit, to the UE, the PDU session details to facilitate an establishment of the PDU session.

In an embodiment, the instructions, when executed by the at least one processor individually or collectively, cause the CU-CP NF to transmit, to an access and mobility management function (AMF), the NAS message comprising the PDU session establishment request and receive, from the AMF, the decoded NAS message

In an embodiment, wherein the instructions, when executed by the at least one processor individually or collectively, cause the CU-CP NF to transmit, to a NAS decoder function (NDF), the NAS message comprising the PDU session establishment request and receive, from the NDF, the decoded NAS message.

In an embodiment, the CU-CP NF supports a SMF selection in a non-roaming and roaming with local breakout condition and home routed roaming condition.

According to embodiments, a method for PDU session establishment in an end-to-end service-based environment, the method comprises receiving, at a central unit control plane (CU-CP) network function (NF), a non-access stratum (NAS) messages comprising a PDU session establishment request from a user equipment (UE), decoding the NAS message received from the UE by one of: an access and mobility management function (AMF), the CU-CP NF, and a NAS decoder function (NDF) of the end-to-end service-based environment, selecting, by either of the AMF or the CU-CP NF, a session management function (SMF) based on the decoded NAS messages, receiving, by the CU-CP NF, the PDU session details from the selected SMF, and sending, by the CU-CP NF, the PDU session details to the UE to facilitate establishment of the PDU session.

In an embodiment, wherein decoding the NAS message received from the UE by the AMF or the NDF comprises sending, by the CU-CP NF, the NAS message comprising the PDU session establishment request to the AMF or the NDF via Ncucp_PDUSession_Establishment Request and decoding the NAS message by the AMF or the NDF, wherein the NDF is a network function used by any NF consumer to get decoded NAS messages.

In an embodiment, the method comprises sending, by the AMF or the NDF, the decoded NAS messages to the CU-CP NF using Nndf_NASmessage_DecodedMessage.

In an embodiment, the CU-CP NF supports SMF selection in a non-roaming and roaming with local breakout condition and home routed roaming condition.

In an embodiment, in case of the SMF selection in the non-roaming and roaming with local breakout condition, selecting the SMF based on the decoded NAS messages by the CU-CP NF comprises determining whether SMF information is available in the CU-CP NF via local configurations.

In an embodiment, the method further comprises selecting, by the CU-CP NF, the SMF based on the local configurations, when the SMF information is available in the CU-CP NF via the local configurations.

In an embodiment, when the SMF information is unavailable in the CU-CP NF via local configurations and when the CU-CP NF is aware of an appropriate network repository function (NRF), the method comprises querying, by the CU-CP NF, the NRF in a serving public land mobile network (PLMN) using Nnrf_cucpDiscovery_Request, wherein the Nnrf_cucpDiscovery_Request comprises at least a single network slice selection assistance information (S-NSSAI) of the serving PLMN, PLMN ID of subscription permanent identifier (SUPI), data network name (DNN), and network slice instance (NSI) ID if the AMF has stored an NSI ID for the S-NSSAI of the serving PLMN for the PDU session from allowed NSSAI and receiving, by the CU-CP NF from the NRF, fully qualified domain name (FQDN) or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In an embodiment, when the SMF information is unavailable in the CU-CP NF via local configurations and when the CU-CP NF is unaware of an appropriate network repository function (NRF), the method comprises invoking Ncucp_NssfSelection_Get service operation from a network slice selection function (NSSF) in a serving PLMN with S-NSSAI of the serving PLMN from allowed NSSAI requested by the UE, with PLMN ID of SUPI, tracking area identity (TAI) of the UE, and an indication of the PDU Session establishment being either from non-roaming or roaming with local breakout scenario, receiving, form the NSSF in serving PLMN, information of an NRF to be used to select NFs/services within a selected Network Slice instance, querying, by the CU-CP NF, the NRF in serving PLMN using Nnrf_cucpDiscovery_Request, wherein the Nnrf_cucpDiscovery_Request comprises at least S-NSSAI of the serving PLMN for the PDU Session from allowed NSSAI, PLMN ID of SUPI, DNN and NSI ID if the AMF has stored an NSI ID for the S-NSSAI of the serving PLMN for the PDU session from the allowed NSSAI, and receiving, by the CU-CP NF from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In an embodiment, in case of the SMF selection in home routed roaming condition, selecting the SMF based on the decoded NAS messages by the CU-CP NF comprises determining whether the CU-CP NF is aware of a NRF to be used to select NFs/services in HPLMN.

In an embodiment, when the CU-CP NF is unaware of the NRF to be used to select the NFs/services in the HPLMN, the method comprises invoking the Ncucp_NssfSelection_Get Request service operation from the NSSF in a VPLMN with a VPLMN S-NSSAI, a HPLMN S-NSSAI, a PLMN ID of the SUPI, a TAI of the UE, and an indication that PDU Session establishment is in the home-routed roaming condition, receiving, from the NSSF in the VPLMN, information of a vNRF to be used to select NFs/services, querying the NRF via Nnrf_cucpDiscovery_Request, and receiving, by the CU-CP NF from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In an embodiment, upon selection of the SMF by the AMF, the method further comprises determining, by the AMF, whether the AMF have an association with any SMF for the PDU session ID provided by the UE, sending, by the AMF, Nsmf_PDUSession_CreateSMContext Request to the selected SMF, wherein Nsmf_PDUSession_CreateSMContext Request creates an AMF-SMF association to support the PDU session, when an association of the AMF with any SMF is unavailable, receiving, by the AMF, at least one of SMF context ID, SMF ID, and SMF related information of the selected SMF via Nsmf_PDUSession_CreateSMContext Response from the selected SMF, sending, by the AMF, at least one of the SMF context ID, the SMF ID, and the SMF related information of the selected SMF to the CU-CP NF, and receiving, by the CU-CP NF, the PDU session details via Ncucp_Communication_MessageTransfer from the selected SMF.

In an embodiment, upon selection of the SMF by the CU-CP NF, the method further comprises sending, by the CU-CP NF, details of the selected SMF to the AMF via Ncucp_EventExposure_Notify, subscribing, by the AMF, to the selected SMF via using Nsmf_EventExposure_Subscribe service operation upon receiving the SMF details from the CU-CP NF, sending, by the CU-CP NF, Ncucp_PDUSession_CreateSMContext Request to the selected SMF, wherein Ncucp_PDUSession_CreateSMContext Request creates an CU-CP-SMF association to support the PDU session, when an association of the CU-CP NF with any SMF is unavailable, receiving, by the CU-CP NF, at least one of SMF context ID, SMF ID, and SMF related information of the selected SMF via Ncucp_PDUSession_CreateSMContext Response from the selected SMF, and receiving, by the CU-CP NF, the PDU session details via Ncucp_Communication_MessageTransfer from the selected SMF.

According to embodiments, a system for PDU session establishment in an end-to-end service-based environment comprises a central unit control plane (CU-CP) network function (NF). The CU-CP NF is configured to receive a non-access stratum (NAS) messages comprising a PDU session establishment request from a user equipment (UE), decode the NAS message received from the UE, or to receive decoded NAS message from an access and mobility management function (AMF) or a NAS decoder function (NDF) of the end-to-end service-based environment, select a session management function (SMF) based on the decoded NAS messages or receive an indication, from the AMF, indicative of a selected SMF, receive the PDU session details from the selected SMF, and send the PDU session details to the UE to facilitate establishment of the PDU session.

In an embodiment, to receive the decoded NAS message from the AMF or the NDF, the CU-CP NF is configured to send the NAS message comprising the PDU session establishment request to the AMF or the NDF via Ncucp_PDUSession_Establishment Request, wherein the AMF or the NDF decodes the NAS message, wherein the NDF is a network function used by any NF consumer to get decoded NAS messages.

In an embodiment, the AMF or the NDF is configured to send the decoded NAS messages to the CU-CP NF using Nndf_NASmessage_DecodedMessage.

In an embodiment, in case of the SMF selection in the non-roaming and roaming with local breakout condition, to select the SMF based on the decoded NAS messages, the CU-CP NF is configured to determine whether SMF information is available in the CU-CP NF via local configurations.

In an embodiment, when the SMF information is available in the CU-CP NF via the local configurations, the CU-CP NF is configured to select the SMF based on the local configurations.

In an embodiment, when the SMF information is unavailable in the CU-CP NF via local configurations and when the CU-CP NF is aware of an appropriate network repository function (NRF) the CU-CP NF system is configured to query the NRF in a serving public land mobile network (PLMN) using Nnrf_cucpDiscovery_Request, wherein the Nnrf_cucpDiscovery_Request comprises at least a single network slice selection assistance information (S-NSSAI) of the serving PLMN, PLMN ID of subscription permanent identifier (SUPI), data network name (DNN), and network slice instance (NSI) ID if the AMF has stored an NSI ID for the S-NSSAI of the serving PLMN for the PDU session from allowed NSSAI, and receive from the NRF, fully qualified domain name (FQDN) or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In an embodiment, when the SMF information is unavailable in the CU-CP NF via local configurations and when the CU-CP NF is unaware of an appropriate NRF, the CU-CP NF system is configured to invoke Ncucp_NssfSelection_Get service operation from a network slice selection function (NSSF) in a serving PLMN with S-NSSAI of the serving PLMN from allowed NSSAI requested by the UE with PLMN ID of SUPI, tracking area identity (TAI) of the UE, and an indication of the PDU Session establishment being either from non-roaming or roaming with local breakout scenario, receive, form the NSSF in serving PLMN, information of an NRF to be used to select NFs/services within a selected Network Slice instance; query the NRF in serving PLMN using Nnrf_cucpDiscovery_Request, wherein the Nnrf_cucpDiscovery_Request comprises at least S-NSSAI of the serving PLMN for the PDU Session from allowed NSSAI, PLMN ID of SUPI, DNN and NSI ID if the AMF has stored an NSI ID for the S-NSSAI of the serving PLMN for the PDU session from the allowed NSSAI, and receive, from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In an embodiment, in case of the SMF selection in home routed roaming condition, to select the SMF based on the decoded NAS messages, the CU-CP NF is configured to determine a NRF is available for selection of NFs/services in HPLMN.

In an embodiment, when the CU-CP NF is unaware of the NRF to be used to select the NFs/services in the HPLMN, the CU-CP NF is configured to invoke the Ncucp_NssfSelection_Get Request service operation from the NSSF in a VPLMN with a VPLMN S-NSSAI, a HPLMN S-NSSAI, a PLMN ID of the SUPI, a TAI of the UE, and an indication that PDU Session establishment is in the home-routed roaming condition, receive, from the NSSF in the VPLMN, information of a vNRF to be used to select NFs/services, query the NRF via Nnrf_cucpDiscovery_Request, and receive, from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

In an embodiment, upon selection of the SMF by the AMF, the AMF is configured to determine whether the AMF have an association with any SMF for the PDU session ID provided by the UE, send Nsmf_PDUSession_CreateSMContext Request to the selected SMF, wherein Nsmf_PDUSession_CreateSMContext Request creates an AMF-SMF association to support the PDU session, when an association of the AMF with any SMF is unavailable, receive at least one of SMF context ID, SMF ID, and SMF related information of the selected SMF via Nsmf_PDUSession_CreateSMContext Response from the selected SMF, and send at least one of the SMF context ID, the SMF ID, and the SMF related information of the selected SMF to the CU-CP NF, and wherein the CU-CP NF is configured to receive the PDU session details via Ncucp_Communication_MessageTransfer from the selected SMF.

In an embodiment, upon selection of the SMF by the CU-CP NF, the CU-CP NF system is configured to send details of the selected SMF to the AMF via Ncucp_EventExposure_Notify, and wherein the AMF is configured to subscribe to the selected SMF via using Nsmf_EventExposure_Subscribe service operation upon receiving the SMF details from the CU-CP NF, send Ncucp_PDUSession_CreateSMContext Request to the selected SMF, wherein Ncucp_PDUSession_CreateSMContext Request creates an CU-CP-SMF association to support the PDU session, when an association of the CU-CP NF with any SMF is unavailable, receive at least one of SMF context ID, SMF ID, and SMF related information of the selected SMF via Ncucp_PDUSession_CreateSMContext Response from the selected SMF, and receive the PDU session details via Ncucp_Communication_MessageTransfer from the selected SMF.

The order in which the various operations of the methods are described is not intended to be construed as a limitation, and any number of the method described blocks can be combined in any order to implement the method. Additionally, individual blocks may be deleted from the methods without departing from the spirit and scope of the subject matter described herein. Furthermore, the methods can be implemented in any suitable hardware, software, firmware, or combination thereof.

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in Figures, those operations may be performed by any suitable corresponding counterpart means-plus-function components.

Furthermore, one or more computer-readable storage media may be utilized in implementing embodiments consistent with the disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., non-transitory. Examples include Random Access Memory (RAM), Read-Only Memory (ROM), volatile memory, nonvolatile memory, hard drives, Compact Disc (CD) ROMs, Digital Video Disc (DVDs), flash drives, disks, and any other known physical storage media.

Certain aspects may comprise a computer program for performing the operations presented herein. For example, such a computer program product may comprise a computer readable media having instructions stored (and/or encoded) thereon, the instructions being executable by one or more processors to perform the operations described herein. For certain aspects, the computer program product may include packaging material.

Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise. The enumerated listing of items does not imply that any or all of the items are mutually exclusive, unless expressly specified otherwise. The terms “a”, “an” and “the” mean “one or more”, unless expressly specified otherwise.

A description of an embodiment with several components in communication with each other does not imply that all such components are required. On the contrary a variety of optional components are described to illustrate the wide variety of possible embodiments of the disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a central unit control plane (CU-CP) network function (NF) for protocol data unit (PDU) session establishment in an end-to-end service-based environment, the method comprising:
receiving, from a user equipment (UE), a non-access stratum (NAS) message comprising a PDU session establishment request;
obtaining a decoded NAS message in response to receiving the NAS message;
selecting a session management function (SMF) based on the decoded NAS message;
receiving, from the selected SMF, PDU session details; and
transmitting, to the UE, the PDU session details to facilitate an establishment of the PDU session.

2. The method of claim 1, wherein the obtaining of the decoded NAS message comprises:
transmitting, to an access and mobility management function (AMF), the NAS message comprising the PDU session establishment request, and
receiving, from the AMF, the decoded NAS message.

3. The method of claim 1, wherein the obtaining of the decoded NAS message comprises:
transmitting, to a NAS decoder function (NDF), the NAS message comprising the PDU session establishment request, and
receiving, from the NDF, the decoded NAS message.

4. The method of claim 1, wherein the CU-CP NF supports a SMF selection in a non-roaming and roaming with local breakout condition and home routed roaming condition.

5. The method of claim 1, wherein, in case of a SMF selection in a non-roaming and roaming with local breakout condition, selecting the SMF based on the decoded NAS message comprises:
determining whether SMF information is available in the CU-CP NF via local configurations.

6. The method of claim 5, further comprises:
selecting the SMF based on the local configurations, when the SMF information is available in the CU-CP NF via the local configurations.

7. The method of claim 5, wherein when the SMF information is unavailable in the CU-CP NF via the local configurations and when the CU-CP NF is aware of a network repository function (NRF), the method comprises:
querying, the NRF in a serving public land mobile network (PLMN) using Nnrf_cucpDiscovery_Request, wherein the Nnrf_cucpDiscovery_Request comprises at least single network slice selection assistance information (S-NSSAI) of the serving PLMN, a PLMN ID of subscription permanent identifier (SUPI), a data network name (DNN), and a network slice instance (NSI) ID if an AMF has stored the NSI ID for the S-NSSAI of the serving PLMN for the PDU session from allowed NSSAI; and
receiving, from the NRF, a fully qualified domain name (FQDN) or an internet protocol (IP) address of a set of the discovered SMF instance(s) or endpoint address(es) of SMF service instance(s) via a Nnrf_cucpDiscovery_Response message and an NSI ID for a selected network slice instance corresponding to the S-NSSAI for subsequent NRF queries.

8. The method of claim 5, wherein when the SMF information is unavailable in the CU-CP NF via the local configurations and when the CU-CP NF is unaware of a network repository function (NRF), the method comprises:
invoking an Ncucp_NssfSelection_Get service operation from a network slice selection function (NSSF) in a serving public land mobile network (PLMN) with single network slice selection assistance information (S-NSSAI) of the serving PLMN from allowed NSSAI requested by the UE, with a PLMN ID of SUPI, a tracking area identity (TAI) of the UE, and an indication of the PDU Session establishment being either from non-roaming or roaming with local breakout scenario;
receiving, from the NSSF in the serving PLMN, information of an NRF to be used to select NFs/services within a selected network slice instance;
querying the NRF in the serving PLMN using an Nnrf_cucpDiscovery_Request, wherein the Nnrf_cucpDiscovery_Request comprises at least S-NSSAI of the serving PLMN for the PDU session from the allowed NSSAI, the PLMN ID of SUPI, a data network name (DNN) and a network slice instance (NSI) ID if an access and mobility management function (AMF) has stored the NSI ID for the S-NSSAI of the serving PLMN for the PDU session from the allowed NSSAI; and
receiving, from the NRF, a fully qualified domain name (FQDN) or an IP address of a set of the discovered SMF instance(s) or endpoint address(es) of SMF service instance(s) via a Nnrf_cucpDiscovery_Response message and the NSI ID for the selected network slice instance corresponding to the S-NSSAI for subsequent NRF queries.

9. The method of claim 4, wherein, in case of the SMF selection in home routed roaming condition, selecting the SMF based on the decoded NAS message comprises:
determining whether the CU-CP NF is aware of a network repository function (NRF) to be used to select NFs/services in a home public land mobile network (HPLMN).

10. The method of claim 9, wherein when the CU-CP NF is unaware of the NRF to be used to select the NFs/services in the HPLMN, the method comprises:
invoking a Ncucp_NssfSelection_Get Request service operation from a network slice selection function (NSSF) in a visited public land mobile network (VPLMN) with VPLMN S-NSSAI, HPLMN S-NSSAI, a PLMN ID of a subscription permanent identifier (SUPI), a tracking area identity (TAI) of the UE, and an indication that PDU session establishment is in a home-routed roaming condition;
receiving, from the NSSF in the VPLMN, information of a vNRF to be used to select NFs/services;
querying the NRF via Nnrf_cucpDiscovery_Request; and
receiving, from the NRF, FQDN or IP address of a set of the discovered SMF instance(s) or endpoint address(es) of SMF service instance(s) via a Nnrf_cucpDiscovery_Response message and an NSI ID for a selected network slice instance corresponding to the S-NSSAI for subsequent NRF queries.

11. The method of claim 1, wherein upon selection of the SMF by the CU-CP NF, the method further comprises:
transmitting, to the selected SMF, Ncucp_PDUSession_CreateSMContext Request, wherein Ncucp_PDUSession_CreateSMContext Request creates an CU-CP-SMF association to support the PDU session, when an association of the CU-CP NF with any SMF is unavailable;
receiving, from the selected SMF, at least one of SMF context ID, SMF ID, and SMF related information of the selected SMF via Ncucp_PDUSession_CreateSMContext Response; and
receiving, from the selected SMF, the PDU session details via Ncucp_Communication_MessageTransfer.

12. A central unit control plane (CU-CP) network function (NF) for PDU session establishment in an end-to-end service-based environment, the CU-CP NF comprising:
communication circuitry;
at least one processor including processing circuitry; and
memory, including one or more storage media, storing instructions that, when executed by the at least one processor individually or collectively, cause the CU-CP NF to:
receive, from a user equipment (UE), a non-access stratum (NAS) message comprising a PDU session establishment request;
obtain a decoded NAS message in response to receiving the NAS message;
select a session management function (SMF) based on the decoded NAS message;
receive, from the selected SMF, PDU session details; and
transmit, to the UE, the PDU session details to facilitate an establishment of the PDU session.

13. The CU-CP NF of claim 12, wherein the instructions, when executed by the at least one processor individually or collectively, cause the CU-CP NF to:
transmit, to an access and mobility management function (AMF), the NAS message comprising the PDU session establishment request, and
receive, from the AMF, the decoded NAS message.

14. The CU-CP NF of claim 12, wherein the instructions, when executed by the at least one processor individually or collectively, cause the CU-CP NF to:
transmit, to a NAS decoder function (NDF), the NAS message comprising the PDU session establishment request, and
receive, from the NDF, the decoded NAS message.

15. The CU-CP NF of claim 12, wherein the CU-CP NF supports a SMF selection in a non-roaming and roaming with local breakout condition and home routed roaming condition.

16. The CU-CP NF of claim 12, wherein the instructions, when executed by the at least one processor individually or collectively, cause the CU-CP NF to:
determine whether SMF information is available in the CU-CP NF via local configurations.

17. The CU-CP NF of claim 16, wherein the instructions, when executed by the at least one processor individually or collectively, cause the CU-CP NF to:
select the SMF based on the local configurations, when the SMF information is available in the CU-CP NF via the local configurations.

18. The CU-CP NF of claim 16, wherein the instructions, when executed by the at least one processor individually or collectively, cause the CU-CP NF to:
query, a network repository function (NRF) in a serving public land mobile network (PLMN) using Nnrf_cucpDiscovery_Request, wherein the Nnrf_cucpDiscovery_Request comprises at least a single network slice selection assistance information (S-NSSAI) of the serving PLMN, a PLMN ID of a subscription permanent identifier (SUPI), data network name (DNN), and a network slice instance (NSI) ID if an access and mobility management function (AMF) has stored the NSI ID for the S-NSSAI of the serving PLMN for the PDU session from allowed NSSAI; and
receive, from the NRF, fully qualified domain name (FQDN) or IP address of a set of the discovered SMF instance(s) or endpoint address(es) of SMF service instance(s) via a Nnrf_cucpDiscovery_Response message and an NSI ID for a selected network slice instance corresponding to the S-NSSAI for subsequent NRF queries.

19. The CU-CP NF of claim 16, wherein the instructions, when executed by the at least one processor individually or collectively, cause the CU-CP NF to:
invoke Ncucp_NssfSelection_Get service operation from a network slice selection function (NSSF) in a serving PLMN with S-NSSAI of the serving PLMN from allowed NSSAI requested by the UE, with PLMN ID of SUPI, tracking area identity (TAI) of the UE, and an indication of the PDU Session establishment being either from non-roaming or roaming with local breakout scenario;
receive, form the NSSF in serving PLMN, information of an NRF to be used to select NFs/services within a selected Network Slice instance;
query the NRF in serving PLMN using Nnrf_cucpDiscovery_Request, wherein the Nnrf_cucpDiscovery_Request comprises at least S-NSSAI of the serving PLMN for the PDU Session from allowed NSSAI, PLMN ID of SUPI, DNN and NSI ID if an access and mobility management function (AMF) has stored an NSI ID for the S-NSSAI of the serving PLMN for the PDU session from the allowed NSSAI; and
receive, from the NRF, FQDN or IP address of a set of the discovered SMF instance(s) or endpoint address(es) of SMF service instance(s) via a Nnrf_cucpDiscovery_Response message and an NSI ID for the selected network slice instance corresponding to the S-NSSAI for subsequent NRF queries.

20. The CU-CP NF of claim 15, wherein the instructions, when executed by the at least one processor individually or collectively, cause the CU-CP NF to:
determine whether the CU-CP NF is aware of a NRF to be used to select NFs/services in HPLMN.
